(19) United States
(12) Patent Application Publication
(10) Pub. No.: US 2023/0036186 A1
(43) Pub. Date: Feb. 2, 2023

(54) SYSTEMS AND METHODS FOR DATA INTEGRATION

(71) Applicant: ANDREW BLUM, HARVEY, LA (US)

(72) Inventor: ANDREW BLUM, HARVEY, LA (US)

(21) Appl. No.: 17/815,135

(22) Filed: Aug. 25, 2022

Related U.S. Application Data
(60) Provisional application No. 63/225,581, filed on Jul. 26, 2021.

(51) Int. Cl. G06F 16/25; G06F 16/28

(52) U.S. Cl. CPC G06F 16/254; G06F 16/283

(57) ABSTRACT

Embodiments of the invention relate generally to system and methods for data integration. In particular, embodiments of the invention are directed to systems and methods for creating, executing, and/or monitoring data pipelines. In one embodiment, a system for data integration includes pipeline templates having standards behaviors associated with the pipeline templates. In some embodiments, a pipeline metadata document (PMD) includes properties associated with the standard behaviors. In certain embodiments, at run time, the properties of the behaviors are set according to data contained in a PMD. In one embodiments, a PMD includes Source, Target, Source-to-Target Mapping, and behavior properties for a given data pipeline. In some embodiments, the PMD can be built based upon data input from roles including Solution Architect, Data Architect, Data Analyst, Data Engineer, and Data Quality Specialist. In one embodiment, a pipeline template can include Begin, Acquire, Process, Package, Transmit, and End stages.

### BACKGROUND

### Field

Embodiments of the invention relate generally to system and methods for data integration. In particular, embodiments of the invention are directed to systems and methods for creating, executing, and/or monitoring data pipelines.

### Description of Related Art

A typical data integration system can include a collection of software programs for extracting data from one or more data sources (“Sources”), processing the extracted data, and providing the processed data to one or more data sinks (“Targets”). As an example, a data integration system for an insurance company that has acquired other insurance companies may extract policy and claim data from the databases of the acquired companies, transform and validate the data in some way, and provide validated and transformed data to analytical platforms for assessing risk management, compliance with regulations, fraud, and the like.

Between a Source and a Target, a data pipeline can be provided as a software platform to move and transform data from the Source to the Target. Typically, data from the Source received by the Target is processed by the data pipeline in some way. For example, a Target may receive data from the data pipeline that is a combination (for example, a join) of data from multiple Sources, all without the Target being configured to process the individual constituent data formats.

A purpose of a data pipeline is to perform data transformations on data obtained from Sources to provide the data in a format expected by the Target. A data transformation can be computer instructions which, when executed by the data pipeline, transform one or more source data sets to produce one or more target data sets. Data that passes through the data pipeline can undergo multiple data transformations. A transformation can have dependencies on transformations that precede it. One example of a computer system for carrying out transformations in a data pipeline is MapReduce. See, for example, Dean, Jeffrey, et al., “MapReduce: Simplified Data Processing on Large Clusters”, Google, Inc., 2004.

Often data pipelines are maintained manually. That is, a software engineer or system administrator is responsible for configuring the system so that transformations are executed in the proper order and on the correct datasets. If a transformation needs to be added, removed, or changed, the engineer or administrator typically reconfigures the data pipeline by manually editing control scripts or other software programs. Similar editing tasks may be needed before the data pipeline can process new datasets. Overall, current approaches for maintaining existing data pipelines may require significant human resources.

Given the increasing amount of data collected by businesses and other organizations, processing data of all sorts through data pipelines can only be expected to increase. This trend is coupled with a need for improved ways to maintain such systems and for the ability to standardize data pipeline creation, execution, and monitoring.

Data professionals face various challenges in data integration. Data Integration routines have not solved data quality issues. Often data quality issues emerge because of inconsistencies from one data pipeline to the next. Different projects and engineers handle data quality issues differently. This lack of consistency causes a lack of confidence in data quality.

Based on known (extraction-transformation-loading) ETL tools and techniques there is a misperception that it is easy or inexpensive to build data pipelines because there are user interface (UI) wizards. This misperception is perpetuated by a data integration business model that relies on some consulting businesses providing large numbers of workers to big consumer institutions to build, monitor, and maintain thousands of data pipelines.

There are maintenance challenges. If it is necessary to design a pipeline with a UI, or to develop a shell script, for every instance of a data pipeline, then this can result in thousands of data pipelines requiring maintenance. Maintenance costs are exacerbated because of the time it takes to track down errors. The lack of consistency forces a large increase in operational staff to track down errors, and inconsistent or non-governed pipeline behaviors multiply the maintenance costs.

Security is another challenge facing data integration projects. It is necessary to guard against, for example, malicious attempts to save data off premises through code placed in a pipeline. Data needs to be protected while at rest. While often encryption at a drive or computer level is common, such solutions fail where, for example, an employee falls for a phishing attack. Unencrypted files at landing zones are very vulnerable.

Known methods tend to encourage developers to write one script per data resource. This often works when moving small numbers of data resources, such as twenty for example. If there are hundreds or thousands of data resources, then this requires maintaining many scripts typically written by numerous differing project teams. A solution to this problem has been proposed with template driven programming. However, these initiatives often involve moving data from a particular Source to a particular Target, rather than using templating to move data from any Source to any Target.

### SUMMARY OF ILLUSTRATIVE EMBODIMENTS

Data integration projects face challenges bringing together the right expertise. There are pipeline behaviors that can be common across multiple pipelines. However, under known methods, typically pipeline behaviors are not developed once and made reusable by different pipelines. Some embodiments disclosed herein address the need for scale where dozens of projects may be concurrently active.

In one aspect, the invention concerns a method of data integration. The method can include providing a plurality of pipeline templates for moving data from a source to a target, wherein each of the pipeline templates comprises at least one behavior; providing a pipeline metadata document comprising configuration data associated with the properties of the at least one behavior; at run time, based at least in part on the pipeline metadata document, retrieving at least one pipeline template from the plurality of templates and setting the properties of the at least one behavior associated with the at least one pipeline template retrieved.

In one embodiment, the method further includes receiving a trigger for executing the at least one pipeline template. In some embodiments, retrieving the at least one pipeline template further involves retrieving the at least one pipeline template based at least in part on a context associated with the trigger.

In certain embodiments, the method further includes retrieving the pipeline metadata document based at least in part on a context associated with the trigger. In one embodiment, the method further involves executing the at least one pipeline template, wherein executing can include acquiring a source data from the source; applying the at least one behavior to the source data to produce transformed data; and transferring the transformed data to the target. In some embodiments, the method further includes monitoring execution of the at least one pipeline template to record associated statistics; the associated statistics can be start time, stop time, and/or errors.

In one embodiment, the method includes providing a pipeline metadata document that has data associated with the execution of the at least one pipeline templates, and wherein the data includes data based on input provided by multiple roles. In some embodiments, the roles include Customer, Solution Architect, Data Architect, Data Analyst, Data Engineer, and/or Data Quality Specialist.

Another aspect of the invention is directed to a method of data integration. The method can include providing a plurality of pipeline templates for moving data from a source to a target, wherein each of the pipeline templates comprises at least one behavior; providing a pipeline metadata document comprising configuration data associated with the properties of the at least one behavior, wherein the configuration data comprises data provided at least in part from input received from Customer, Solution Architect, Data Architect, Data Analyst, Data Engineer, and Data Quality Specialist roles; receiving a trigger signal associated with a request for processing a data resource; based at least in part on a context associated with the trigger signal, retrieving at least one pipeline template from the plurality of templates and retrieving the pipeline metadata document; at run time, based at least in part on the pipeline metadata document setting the properties of the behaviors associated with the at least one pipeline template; executing the at least one pipeline template, wherein executing involves: acquiring the data resource; applying the behaviors to the data resource to produce transformed data; transferring the transformed data to the target; and monitoring execution of the at least one pipeline template to record start time, stop time, and/or errors.

Yet another aspect of the invention concerns a method of governing and implementing data integration. The method can involve providing a plurality of standard behaviors, wherein the standard behaviors are configured to be reusable across different data pipelines, wherein each of the standard behaviors comprises one or more properties, wherein the standard behaviors are configurable according to predetermined rules; providing a pipeline metadata document comprising configuration data associated with the properties of the standards behaviors, wherein the configuration data comprises data created at least in part from input received from each of roles of a set of roles comprising Solution Architect, Data Architect, and Data Quality Specialist; and at run time, based at least in part on the pipeline metadata document, setting the properties of the standard behaviors. The method can further include applying the plurality of standard behaviors to a data resource to produce transformed data. In some embodiments, the method can further involve monitoring execution of the standard behaviors to record start time, stop time, and/or errors associated with the data pipelines. In certain embodiments, the predetermined rules are established by an organization. In one embodiment, the roles can include at least one of Customer, Data Analyst, and/or Data Engineer.

Another aspect of the invention is related to a method of building a pipeline metadata document (PMD) for use in data integration. The method can include generating a new PMD object; providing in the PMD object data that specifies: at least one Source and at least one Target; a source-to-target map having at least one transformation rule; properties for configuring the behaviors of a pipeline template; and data quality rules; and storing the PMD object for later use in conjunction with the pipeline template. In one embodiment, data in the PMD object includes (x) custom code and/or (y) instructions associated with accessing custom code.

Yet another aspect of the invention is directed to a system for facilitating data integration, the system comprising: a pipeline metadata document (PMD); a plurality of standard behaviors that can be configured at run time with data provided in the PMD; wherein the PMD comprises specifications for: at least one Source and at least one Target; at least one property associated with at least one standard behavior; and a source-to-target map. In one embodiment, the system further includes a plurality of pipeline templates, wherein each of the pipeline templates has at least one standard behavior. In some embodiments, at least one of the plurality of templates comprises Begin, Acquire, Process, Post-process, Transmit, and End stages, and wherein each of the stages is associated with at least one standard behavior.

In one embodiment, the invention is directed to a method of facilitating data integration. Thethe method involves providing a pipeline metadata document (PMD); after initiation of execution of a data integration pipeline, retrieving the PMD, wherein the data integration pipeline has at least one behavior, the at least one behavior having at least one behavior property; wherein the PMD comprises data associated with the at least one behavior property; and setting the at least one behavior property with said data associated with the at least one behavior property.

The method can include providing a document having data associated with source information, target information, source-to-target map, and behaviors. The method can include providing at least one data integration pipeline template for moving data from a source to a target, wherein each the at least one pipeline template comprises at least one behavior. In some embodiments, the method can include executing the at least one data integration pipeline template, wherein executing involves: acquiring a source data from the source; applying the at least one behavior to the source data to produce transformed data; and transferring the transformed data to the target.

In certain embodiments, the method can involves providing data associated with the execution of least one pipeline template, and wherein said providing data further comprises providing data based on input provided by multiple roles. In one embodiment, the method can include providing data provided by a Customer, Solution Architect, Data Architect, Data Analyst, Data Engineer, and Data Quality Specialist.

Yet another aspect of the invention is concerned with a system for facilitating data integration. The system can include a user interface (UI) for generating at least one pipeline metadata document (PMD); at least one PMD; an integration engine configured to retrieve and execute the at least one PMD after initiation of the execution of a data integration pipeline; wherein the integration engine is further configured to execute at least one behavior, the at least one behavior comprising at least one behavior property; and wherein the PMD comprises at least one specification associated with the at least one behavior property.

In one embodiment, the UI is configured to communicate with at least one external data source to facilitate generating the PMD. In some embodiments, the system includes at least one data integration pipeline template. In certain embodiments, the data integration pipeline template has at least one behavior. In one embodiment, the system includes a universal data mover (UDM) component; the UDM can include a set of data integration templates, said set of data integration templates having templates for data integration file-to-file, database-to-database, stream-to-stream, api-to-api, file-to-database, database-to-file, stream-to-file, api-to-file, file-to-stream, database-to-stream, stream-to-database, api-to-database, file-to-api, database-to-api, stream-to-api, and api-to-stream.

In some embodiment, the data integration pipeline template includes at least one stage of execution. The stages of execution can be begin, acquire, process, package, transmit, and end. In some embodiments, the system includes a pipeline router component configured to identify a specific PMD.

Yet another aspect of the invention pertains to a pipeline metadata document (PMD) for use in data integration. In one embodiment, the PMD includes a first structure configured to store information associated with a data source; a second structure configured to store information associated with a data target; a third structure configured to store information associated with a source-to-target mapping; and a fourth structure configured to store information associated with behaviors of a data integration pipeline. In some embodiments, the first structure includes data associated with source properties and source fields; the second structure includes data associated with target properties and target fields; the third structure includes data associated with a source field, a source target, and a transformation rule; and the fourth structure comprises data associated with behavior properties and behavior type. In certain embodiments, the PMD is configured to be stored in, and retrieved from, a repository configured to store a plurality of PMDs.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 is a block diagram of a data integration system in accordance with one embodiment of the invention.

FIG. 2 is a diagram of a data integration system in accordance with another embodiment of the invention.

FIG. 3 is a flowchart of a method of facilitating data integration in accordance with one embodiment of the invention.

FIG. 4 is a flowchart of a method of facilitating data integration in accordance with another embodiment of the invention.

FIG. 5 is a flowchart of a method of facilitating data integration in accordance with yet another embodiment of the invention.

FIG. 6 is a block diagram illustrating a pipeline metadata document (PMD) in accordance with one embodiment of the invention.

FIG. 7 is a block diagram of an exemplary Source Information object that can be used with the PMD of FIG. 6.

FIG. 8 is a block diagram of an exemplary Target Information object that can be used with the PMD of FIG. 6.

FIG. 9 is a block diagram of an exemplary Field object that can be used with the Source Information object of FIG. 7 and/or the Target Information object of FIG. 8.

FIG. 10 is a block diagram of an exemplary Data Quality Rules object that can be used with the Field object of FIG. 9.

FIG. 11 is a block diagram of an exemplary Source-to-Target Map object that can be used with the PMD of FIG. 6.

FIG. 12 is a block diagram of an exemplary Transformation Rule object that can be used with the Source-to-Target Map object of FIG. 9.

FIG. 13 is a block diagram of an exemplary Behavior object that can be used with the PMD of FIG. 6.

FIG. 14 is a block diagram of an exemplary Global Property object that can be used with the PMD of FIG. 6.

FIG. 15 is a block diagram of an exemplary pool of Standard Behaviors that can be used with the data integration system of FIG. 1 and/or the data integration system of FIG. 2.

FIG. 16 is a block diagram of another exemplary pool of Standard Behaviors that can be used with the data integration system of FIG. 1 and/or the data integration system of FIG. 2.

FIG. 17 is a block diagram of an exemplary pipeline template that can be used with the data integration system of FIG. 1 and/or the data integration system of FIG. 2.

FIG. 18 is a block diagram of another exemplary pipeline template that can be used with the data integration system of FIG. 1 and/or the data integration system of FIG. 2.

FIG. 19 is an illustration of an exemplary computer program that can be used to implement the PMD of FIG. 6.

FIG. 20 is a is flowchart of a method of data integration according to one embodiment of the invention.

FIG. 21 is the first part of a sequence diagram of a method of data integration according to one embodiment of the invention.

FIG. 22 is the second part of the sequence diagram of FIG. 21.

FIG. 23 is a sequence diagram of another method of data integration according to certain embodiments of the invention.

FIG. 24 is a block diagram of an exemplary computing system environment that can be used to implement embodiments of the invention.

FIG. 25 is a block diagram of an exemplary software system for controlling the operation of the computing environment of FIG. 24.

FIG. 26 is a block diagram of a system for data integration according to one embodiment of the invention.

FIG. 27 is a schematic diagram of a user interface that can be used to implement some embodiments of the invention.

FIG. 28 is another view of the user interface of FIG. 27.

FIG. 29 is yet another view of the user interface of FIG. 27.

FIG. 30 is one more view of the user interface of FIG. 27.

FIG. 31 is another view of the user interface of FIG. 27.

FIG. 32 is sequence diagram of a method of data integration according to some embodiments of the invention.

FIG. 33 is a first part of a sequence diagram of yet another method of data integration according to some embodiments of the invention.

FIG. 34 is the second part of the sequence diagram of FIG. 33.

FIG. 35 is a block diagram of an illustrative pipeline metadata base component that can be used with certain embodiments of the invention.

FIG. 36 is a block diagram of a pipeline metadata document component that can be used with certain embodiments of the invention.

FIG. 37 is a block diagram of an illustrative pipeline metadata group that can be used with certain embodiments of the invention.

FIG. 38 is a block diagram of an illustrative behavior type structure that can be used with certain embodiments of the invention.

FIG. 39 is a block diagram of an illustrative field structure type component that can be used with certain embodiments of the invention.

FIG. 40 is a block diagram of an illustrative process execution type structure that can be used with certain embodiments of the invention.

FIG. 41 is a block diagram of an illustrative template type structure that can be used with certain embodiments of the invention.

FIG. 42 is a block diagram of an illustrative data type that can be used with certain embodiments of the invention.

FIG. 43 is a block diagram of an illustrative stage type structure that can be used with certain embodiments of the invention.

FIG. 44 is a block diagram of an illustrative resource type structure that can be used with certain embodiments of the invention.

FIG. 45 is a block diagram of an illustrative behavior component that can be used with certain embodiments of the invention.

FIG. 46 is a block diagram of an illustrative staged behavior component that can be used with certain embodiments of the invention.

FIG. 47 is a block diagram of an illustrative resource component structure that can be used with certain embodiments of the invention.

FIG. 48 is a block diagram of an illustrative field component that can be used with certain embodiments of the invention.

### DETAILED DESCRIPTION OF ILLUSTRATIVE EMBODIMENTS

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to systems and methods for facilitating cross-team consistency in data integration projects. In one embodiment, the invention is directed to a method advantageous to a project that involves various data sources (like files, API's, databases, or streams). Embodiments of the invention are advantageous in projects having large numbers of tables and file definitions because in such projects, under known methods, typically more project teams are used for implementing them.

Data integration is a process of moving data from a Source to a Target. In most cases, this movement of data is from an operational database to a data warehouse. Data integration can involve the conversion of Source data to a format required by the Target. This can include data type transformation, handling missing data, data aggregation, and the like. One step in data transformation is also specifying how to map, modify, join, filter, or aggregate data as required by the Target.

Source to Target (S2T) mapping can specify how data sources can be connected with, for example, a data warehouse during data integration. S2T mapping can provide instructions on, for example, how data sources intersect with each other based on common information, which data record is preferred if duplicate data is found, and the like.

S2T Mapping can involve the following steps. In Step 1, Attributes can be defined. Before data transfer between the Source and the Target starts, the data to be transferred is defined. In practice, this typically means defining the tables and the attributes in those tables to be transferred. In Step 2, Attributes can be mapped. After the data to be transferred has been defined, the data can be mapped according to the Target's attributes. If the data is to be integrated into a data warehouse, for example, denormalization can be required, and hence, the mapping could be complex and error-prone. In a Step 3, the data can be transformed. This step involves converting the data to a format suitable for storing in the Target and homogenized to maintain uniformity.

In an enterprise environment, typically data integration requires an integration layer, which is often an ETL (Extract Transform Load) application. This integration layer sits between a Source, and a Target. The Source can hold raw data from production systems and other sources. The Target is the destination for the data.

In Extraction, data is acquired from the Source. API calls usually do this, but other methods, such as file exports, may be required for some systems. In Transformation, the raw data can be copied into staging tables, and the Target schema is applied. This stage usually involves data cleansing to remove corrupt, empty, or duplicate values. There may also be some normalization or harmonization to improve data quality. In Loading, clean data with the Target schema can be moved to the Target, which is often a data warehouse or similar structure. The integrated data then becomes available for business purposes.

In some embodiments, the integration layer keeps data flowing from Source to a Target. ETL tools can facilitate at least some automation of this data flow. Machine learning and artificial intelligence (AI) can help to refine the Target schema and adapt to any changes in the Sources.

Most businesses have a wide array of Sources, which can include production databases, cloud-based systems such as CRM and ERP, web analytics, and data from partners.

Such businesses may identify business goals that require data integration. Examples of such goals include validation, consolidation, process enablement, master data management, and analytics and business intelligence. In Validation, the business checks the accuracy of data by comparing it to a schema or matching it against data from another Source. In Consolidation, the business centralizes data storage, to improve efficiency or to store big data more cost-effectively. In Process enablement, the business creates a new process that is only possible with an integrated data source. For example, a new marketing automation platform might require a unified source of client data. In Master data management (MDM), if the business uses MDM as part of its data governance strategy, it will use integration techniques to produce master data. In analytics and business intelligence (BI), perhaps the most common application of data integration, the business needs a unified Source for analytics purposes, as well as other BI applications. Data integration can be used to improve efficiency, enable analytics, and solve organizational problems that arise from having siloed data.

Certain embodiments of the inventive systems and methods disclosed here provide a technology-agnostic approach to data integration. Some embodiments can be applied to batch, streams, shell scripts, extract-transform-load (ETL) tools, and event-driven/microservice architectures. Certain embodiments are suitable for on-premises or in-the-cloud platforms. Some embodiments can be implemented on, for example, distributed processing, database management system (DBMS), or a massively parallel processing (MPP) data warehouse.

In one embodiment, the invention is directed to a method of specifying how different tools, teams and roles of a data integration project can work together. In some embodiments, inventive methods can provide a common taxonomy and techniques that can be taught, managed, and implemented.

Certain embodiments of the systems and methods disclosed here are especially suitable when applied in data integration projects involving multiple teams having data integration responsibilities. A data integration job can include moving a data resource from a data source (“Source”) to a data target (“Target”). In some embodiments, a data resource can be one of four types, namely File, API, Database, or Stream. According to some embodiments of the invention, multiple pipeline templates can be provided to facilitate the building of templated data pipelines. In one embodiment, a system can provide, for example, sixteen pipeline templates, which can be the set of pipeline templates sufficient to define any data pipeline. In certain embodiments, the pipeline templates are generic, that is, the pipeline templates can be implemented without dependencies on specific underlying technologies to move a data resource from any Source to any Target. In some embodiments, the pipeline templates can be configured at run time with a pipeline metadata document.

In some embodiments, a pipeline template can include six stages, namely Begin, Acquire, Process, Package, Transmit, and End. In certain embodiments, behaviors associated with a pipeline template can be governable and customizable. In some embodiments, an organization can govern behaviors by establishing standards for how to implement behaviors across templates. In certain embodiments, the standards prohibit different teams to use different implementations duplicative of standard behaviors. In some embodiments, customizations of behaviors can be allowed; however, such modifications must adhere to predetermined standards that govern the behaviors.

In one embodiment, a method of data integration involves providing a number of templates (for example, sixteen templates). The templates can be built using off-the-shelf integration tools, ETL engines tools, and/or custom software. These sixteen templates can be sufficient to move any data resource from any Source to any Target.

Off-the-self tools preferably facilitate building pipeline templates that can reuse standard behaviors, support multiple Sources and Targets, and the properties for behaviors can be set during execution of the data pipeline. Such tools include, for example, NiFi, SSIS, Informatica, AWS Glue, Talend, Pentaho, Airflow, Apache Beam, Google Cloud Flow, Spark, and Azure Data Factory.

In some embodiments, the pipeline templates can be provided with behaviors that are standard across multiple templates. In one embodiment, the behaviors can be governed by, for example, a Data Integration Management Officer function. Behaviors can include, for example, the style of encryption or the type of compression. In some embodiments, the behaviors can be provided as custom code via OS utilities, REST Services, or a Service Mesh micro-service layer, for example.

In some embodiments, the systems and methods of data integration disclosed here do not require a specific technology architecture. Embodiments can be provided in conjunction with different platforms and tools.

In one embodiment of a method of data integration, a signal to process a data resource is generated (or received). Examples of such a signal include a file arriving, schedulers, polling, messaging, a database table triggers, a cloud provider sends a message to a function, and the like. The signal can include an identifier of the data resource that is ready for processing. In some embodiments, a pipeline metadata document is retrieved from a Pipeline Metadata Container (“PMC”) repository. In one embodiment, the PMD unique key is the resource identifier. The container could have multiple documents, the unique key from the signal helps identify a Pipeline Metadata Document (PMD). The PMD can be a document, file, database record, or the like.

In certain embodiments, the PMD is retrieved at the start of the execution of a pipeline template. In some embodiments, information in the PMD can determine the runtime behaviors of the pipeline template. In one embodiment, a pipeline template includes all the governed, standard behaviors, and further facilitates the addition of custom behaviors. In some embodiments, at least twenty governed behaviors can be provided. In certain embodiments, after setting the properties of the pipeline template with the PMD, the pipeline template executes and moves a data resource from a Source to a Target.

In some embodiments, a common language can be provided for building pipeline templates. Certain embodiments facilitate data professionals to communicate via a common taxonomy. A methodology can be provided that specifies the artifacts (such as PMD, pipeline templates having BAPPTE stages, Charter Document, and the like) that can be created by different roles. The roles can include Customer, Project Management Officer, Data Architect, Data Analyst, Data Engineer, QA Specialist, and/or DevOps Specialist. Certain embodiments facilitate a low code approach for data engineers while providing a core team (“Team Alpha”) to maintain pipeline templates and to facilitate data integration projects (for example, train others to use the system and/or methods, maintain the reference documents, and the like) among all the ongoing, diverse projects that use the data integration systems and methods disclosed here.

In some embodiments, a data resource can be one of four types, namely File, API, Database, or Stream. A File is a resource that can store data on a computer storage device. A variety of structures and methods can access the data in a File.

An Application Programming Interface (“API”) can define interactions between software applications. The API specifies the format of the data provided by the API. Most APIs today are REST-based. APIs can include non-web APIs that are callable directly, for example, from Java or C# functions.

A Database is an organized collection of data that can be accessed through a query language or an API. It is usually necessary to understand the structure of the data in the database in order to access the data. Databases include RDMS, Document, Graph, Analytic Store, and Time Series.

A Stream is a sequence of data that can be available over time at a particular address. One example is real-time feeds available via sockets. Examples of streaming systems include Kafka, Kinesis, SQS, SNS, and Service Buses.

In some embodiments, the execution of a pipeline template is based on pipeline metadata that can be injected into the pipeline template at runtime. In one embodiment, a Pipeline Metadata Document (PMD) flows through the whole lifecycle of a data integration project. Preferably the PMD can be a JSON, XML, YAML, or a serialized Java or Python object. The PMD schema can be configured to facilitate providing all the configuration data that describes a data pipeline. In some embodiments, the PMD can be configured to enforce and validate a standard schema, but to be as un-opinionated as possible; that is, for example, the PMD schema need not require a specific naming convention for most properties (name-value pairs). The behaviors executed within a pipeline template can be specified by the PMD schema.

In some embodiments, behaviors can be provided by custom code that is retrieved by a pipeline template after data is acquired, processed, and/or packaged. Pointers to the location of the custom code can be stored in the PMD, for example.

In one embodiment, the PMD can provide a structure that facilitates defining the properties of any resource, whether Source or Target. S2T mapping can be defined as instructions that specify how the structure and content of a Source can be transferred to and stored in a Target. In some embodiments, a Source-to-Target (S2T) Map can be provided to facilitate automating transformations. Information about fields in the Source and Target, as well as transformation rules, can be stored in the PMD.

In certain embodiments, a PMD can contain functions expressed in a Data Expression Analyst Language (DEAL), which is a domain specific language. DEAL includes functions that can be used, for example, as transformations built into the S2T Map and/or to validate data for data quality purposes. This provides consistency, data pipeline transformation, and validation.

In some embodiments, the PMD can generate a user interface that facilitates specifying properties, such as NAME:VALUE, the user can provide the specific contents of the NAME and VALUE.

The use of S2T mapping in conjunction with DEAL can provide an automation strategy. Data engineers, who work with an ETL tool or an in-house framework, do not have to write code to express one-to-one mappings or other basic transformation behaviors. Data analysts or customers can use DEAL to define functions to operate on the data, such as string manipulation, code table lookups, and foreign key column selections for data not in the original Source.

In one embodiment, the lifecycle of the PMD begins when a customer uses an API to order data from a catalog (such as specifying Sources and particular fields, for example). In some embodiments, a user interface can be provided having typical IT request tools such as ServiceNow.

To start a process, a signal can be created by job scheduling, database triggers, file watchers, service busses, modern stream/event systems, and various cloud architectures. Any such approach can provide signals for the inventive systems and methods described here. In one embodiment, a data integration system uses a pipeline router that parses a signal and, based at least in part on information obtained from the signal, determines what pipeline template to execute. In one embodiment, a pipeline template can be executed after a signal is acquired. There are multiple approaches to invoking a pipeline template depending on a given data integration strategy. These approaches include ETL tools, custom frameworks, distributed processing engines, cloud functions, shell scripts, streaming engines, and/or ELT (where data is transformed in latter stages).

For each approach, there can be a preferred architecture. In one embodiment, a message queue can be used as a FIFO buffer to store a message to then execute the pipeline template. This facilitates using a central mechanism for accessing all pipeline templates available. This mechanism can be a router for pipeline template execution, independent of the integration engine that is used. The router can be configured to determine, for example, that for a given Source the sequence is routed to a predetermined integration engine using a predetermined pipeline template.

In certain embodiments, the message queue can provide a separation of concerns between the execution of a pipeline template and the integration engine doing the execution (this approach is advantageous in a non-flow integration engine, for example). This can facilitate having back pressure support independent of a given integration engine.

The PMD can facilitate affecting behavior across all pipeline template executions. For example, the PMD can be changed to support different Sources/Targets locations, or behavior strategy (that is, for example, changing from compression with Zip format to a different compression format). The behavior can be changed at the PMD level, rather than at the level of having to change each pipeline template.

Some data integration systems (external engines, for example) may already have adequate back-pressure support to handle being overwhelmed with messages to execute.

Operating architectures can include ETL/Integration Tool based (Metadata Reference, Global Variables, Direct Property Changes); custom software object-oriented approach; Event/Stream based (Dumb Routes/Smart Endpoints, Smart Routes/Dumb Endpoints); Shell Script Utilities; Cloud Integration Engines (AWS Glue, Azure Data Fabric, Google Cloud Flow).

The triggering approach can determine the pipeline template execution strategy. In one embodiment, if the trigger is Job Scheduling an executable process can be run on a particular server. In some embodiments, a FIFO message queue can be populated with event information. A key to the PMD can be passed to the message queue, after parsing. Then another component can handle direct execution of the pipeline template. This approach is also suitable for existing ETL/Integration systems; in this case, regardless of the template executed, the data integration system starts by reading from the message queue in order to retrieve the PMD for injection into the pipeline template.

In one embodiment, the job scheduler retrieves the PMD and passes it to the FIFO message queue. In some embodiments, a job scheduler directly executes the pipeline template. An executable or another mechanism can be provided that is built into the job scheduler. In one embodiment, the template can be invoked via a REST API call.

In the case of database triggers, in one embodiment, a trigger can be database code that executes in response to database activities such as Insert Row or Create Table. In some embodiments, upon trigger execution the database can execute a call to place data in an external FIFO message queue. The database code that enables inserting into the queue can be an external program, DB specific capability, or REST API call, for example. In certain embodiments, the database can implement its own version of a FIFO message queue in the form of a message queue table. The database trigger inserts a row in the message queue table and another component polls the message queue to identify the latest rows inserted.

In one embodiment, the database can store the PMD and the PMD is passed into the message queue table. In some embodiments, a key to the PMD is determined by means of a field of the message queue table. In yet other embodiments, the database trigger directly calls an appropriate template by executing code on the operating system the database is running on and not on the database itself.

For a File Watcher trigger, in one embodiment, the file watcher monitors a folder for new file creation. Upon discovery, an executable program or script is invoked. In one embodiment, upon the file watcher triggering, a message can be sent to an external FIFO message queue. The executable program can be in any language that can register a signal with operating system level file watcher. In certain embodiments, after a file watcher is triggered a program calls the pipeline template directly.

If the trigger involves an enterprise service bus (ESB) (topics/events) (intelligent pipes, dumb connectors), wherein the ESB provides data integration logic, the logic for the routing of data can be built into the ESB itself. An ESB can be a data integration service. An ESB is not akin to an ETL tool; however, an ESB can connect directly to multiple Sources and Targets. In one embodiment, the Data Integration System can use an ESB if the ESB supports metadata injection into a pipeline template for setting of variables at and/or during runtime.

In some embodiments, a method can include transformations that can be specified by six data integration stages. In certain embodiments, each pipeline template includes the six data integration stages. For any given pipeline template, each stage need not be executed; however, the pipeline template includes the six data integration stages in case they are needed.

A stage can be a sub-template within a pipeline template. In one embodiment, the method facilitates governing the behaviors that are allowed in a given stage. When a stage is implemented via specific code, program methods can be used to replicate the stages as they flow through a set order.

Even within known data integration tools (for example, Microsoft SSIS or Apache NiFi), the stages can be broken into sub-templates. The stages can also be configured to facilitate injection of custom code into the pipeline template. This can be accomplished by having a PostEvent after Acquire, Process, and/or Package that facilitates custom code injection into the pipeline template.

In one embodiment, before pipeline template execution starts, Instrumentation can be used to record the start of the data integration. In some embodiments, Instrumentation is a subset of logging where Start Time, End Time, and Errors can be tracked. Typically, a Control GUID can be provided at the start of a pipeline template; the Control GUID can be used in logging and during target transmission to establish traceability between a database, log, and Instrumentation Data Store.

In one embodiment, the data integration job starts at a Begin stage by obtaining access to resources, Source, Target, and integration tools. At Begin, at the start of the data pipeline, the pipeline metadata can be injected to set the properties for the behaviors of the pipeline template.

In the Acquire stage, the data resource is loaded from the Source according to the requirements of the data integration. For example, the data integration may require only certain data, or it may have a preferred order of data acquisition. In one embodiment, only a File, API, Database, or Stream are acquired. In the case of a file, in one embodiment, data can be decompressed if the file is zip file, and then multiple files from this point can be run through the data pipeline. If the files are based on the same schema, it is possible in Acquire to combine multiple files for ingestion. In one embodiment a Post-Acquire sub-stage can be provided. Post-Acquire can be a place holder for custom code.

In the Process stage, the data acquired is transformed so that the data content and data structure are suitable to the Target as specified by the data integration requirements. The transformations can be simple or complex, and may require access to other data. Within a typical data pipeline, about 80% of the fields represent a one-to-one mapping between the Source and the Target. Using metadata and automation, an integration engine can automatically set these columns in the Target. Some of the remaining 20% of the fields can be covered by processing based on the Data Expression Analyst Language (DEAL). For example, simple string manipulation (such as trim, concat, and basic parsing) need not be programmed; the Data Integration System can handle simple string manipulation. This can be done via local or distributed processing.

Under known methods, often a data analyst manually builds a S2T map, then a data engineer does the coding. This step is typically unnecessary unless custom expressions are needed.

Data quality behaviors can be inserted into the pipeline at Process Stage. Such behaviors can include, for example, Balance and Control, Rule-based Assertions, and Machine Learning algos.

In a Post-Process sub-stage, data engineers can insert custom code. For example, it might be needed to provide additional aggregations, populate multiple Targets with similar data, or store reference data in a cache. The data can be arranged into a format suitable for transfer to the Target. The data that are structured for internal processing can be re-structured to a format required for the Target. At this stage it can be decided to compress, encrypt, or mask the data, for example. In this way data safety can be provided before the data is transmitted to the target, where the data can be vulnerable during initial ingestion.

In some embodiments, a Packaging stage can include creating a TAR ball or a Zip file when the Target is of File type, for example.

In the Transmit stage the data can be transferred to a Target depending on the requirements of the data integration. The data integration may require, for example, format changes and may have a preferred data format. Typically, these options are determined by the capabilities of the Target. Often a file can be ingested into a data warehouse, Cluster, Cloud Storage, or a network addressable disk. If the Target is a File, it is common to use the SFTP protocol to safely transfer the data. If the Target is a database, typically this will be called via a JDBC/ODBC connection. Different, vendor specific, bulk load utilities can be plugged into the pipeline template for database specific bulk-upload purposes.

In the End stage, in one embodiment, the data integration can conclude by verifying success and freeing resources.

These six stages can be sufficient to encapsulate the specification of any data integration pipeline.

A challenge with multiple concurrent teams is that each team often uses a different way of expressing data pipeline behaviors. This is where encapsulation can be advantageous. In one embodiment of a method of data integration, teams must select pipeline templates only from among a predetermined set of pipeline templates (such as the 16 pipeline templates discussed below). In one embodiment, in addition to custom code, each pipeline template can use only predetermined standard behaviors, examples of which are described below.

Formatting. Data formatting can be used to organize information according to pre-defined specifications. JSON (JavaScript Object Notation) is a human readable data file format. CSV (comma-separated values) is a data file format for storing and exchanging tabular data, like databases or spreadsheets. Avro provides data exchange and data serialization services for Apache Hadoop. YAML can be used for data storage and transmission. It is possible to serialize complex structures in YAML. Protobuf (Protocol buffers) can be used to serialize structured data in a language- and platform-neutral format. XML (Extensible Markup Language) can be used to stored data as plain text. XML uses markup symbols to describe the file contents. Parquet can be used to store nested data structures in a columnar format. Parquet can be used to ensure that the values of each column are stored next to each other.

Data logging can be used to systematically record events, observations, or measurements. Instrumentation can be a component of data logging. Instrumentation monitors and records changes in data conditions over a time period. Data lineage can be a component of data logging. Data lineage can provide visibility about origin of data, data transformations, and where the data moved over time.

Key Assignment. Data keys can be a part of data integration systems. A primary data key is a column that uniquely identifies each record in a data table. Data masking can be used to hide original data with modified data, for reasons like cyber threats. Data encryption can be used to encode the data to make the data readable by humans only after decryption. Data Compression. Data compression can be used to store the same amount of data using fewer bytes. Data deduplication can be used to remove duplicate copies from the data.

Schema Evolution. Schema evolution can be used to manage schema changes so as to enable the database schema to change over time without loss of data. Schema Validation. Schema validation can be used to confirm that incoming data conforms to the structure and format expected by a Target.

Pipeline Retry can be used to protect ETL system components from, for example, transient faults, momentary loss of network connectivity, or timeouts. Data transformation can be used to change data format. Data Integration Engine can be used to standardize data flow across disparate data systems.

Source Retrieval can be used to retrieve data from any data source that includes Files, API's, Databases, or Streams. The data is retrieved into a system for further processing. Target Insert/Update can be used to store data after all behaviors have been processed. Instrumentation can be used to track start time, stop time, and any errors in a separate data resource for monitoring, remediation, and performance analysis. Lineage Tracking can be used to track and store information about each change of the data as it is transformed within a data pipeline.

Key Generation can be used within lineage tracking to allow for each Source-To-Target runtime execution to have its own unique identifier for tracing across logging, instrumentation, and initial target database insert. DQ Rules Checks can be used to apply specific rules related to determine if quality is present either within the source data or target data. Data that violates a rule set can be rejected/and or marked as quality deficient. Archive can be used to store data in a permanent non-relational source for processing.

Micro-Batch can be used to limit to small bathes the records retrieved, processed, and stored to ensure performance and that no aspect of the system becomes overloaded due to too much data. Data Science Algorithms can be used within, for example, a data stream to execute data science and machine learning algorithms during processing of data. Custom Code can be used to run specified custom programs by exposing the data within the engine to outside programs coded in languages such as Java and Python.

In one embodiment, transformations can be specified by five components. Source to Target Mapping is a detailed definition for transforming the data between the Source and the Target. The definition can be in the form of a template that can be used by automation to perform the transformation. Configuration Schema specifies the information necessary to connect to and conduct the transformation for the specific Source and Target at runtime. Operational Requirements can include functionality for assuring the quality of the transformations in the runtime environment, such functionality can be instrumentation, monitoring, logging, data quality, and/or audit, for example. Routing can include functionality for performing transformations at scale in the runtime environment, such functionality can be triggering, centralized job routing, and resource allocation. Services can include functionality for data engineering activities; services can be provided as a library and/or an API.

In one embodiment, a method of data integration can provide a Universal Data Mover (UDM) Charter and Mandate, Data Quality Processing Workflow, Intake Workflow, Common Job Definition Schema, Common Operation Platform (Perch), Data Leadership Training, S2T Map Automation, and Data Expression Analyst Language (DEAL).

UDM Charter and Mandate.

Data Quality Processing Workflow. Data input often involves data quality testing and remediation to avoid propagation of quality problems.

Intake Workflow can specify the steps needed to create a new data integration.

Common Job Definition Schema can be a template to facilitate specifying the knowledge needed to perform data integrations.

Common Operations Platform (Perch) can be used to schedule, trigger, and monitor integrations, and to manage resources.

Data Leadership Training can be provided for each role needed to implement the data integration systems and methods disclosed here.

S2T Map Automation can include an extendable library of utilities that can be used to automatically perform an integration based on the S2T map specification.

Data Expression Analyst Language can be used to specify transformations.

Data Integration Stage Swimlane Template can be a structure for specifying the interaction among the data integration stages.

In some embodiments, a method of data integration can advantageously include teams and roles. The use of standard data integrations can be advantageous; hence, in one embodiment, a Data Governance Officer can set standards for data integration governance throughout an organization. In some embodiments, a Master Data Management Data Steward can ensure proper management of the organization's data. In certain embodiments, a Project Delivery Team can perform data integration projects. In one embodiment, an Alpha Team creates pipeline templates consistent with Governance goals, teaches methodology and software code, and/or provides roadmaps. Alpha Team can function as an internal product team. Alpha Team can ensure, for example, that standards (as applied to standard behaviors) are followed.

In some embodiments, Roles can be implemented including, for example, Customer, Solution Architect, Data Analyst, Data Engineer, Project Manager, Data Quality Specialist, DevOps Specialist, and/or Ops-App Manager. The Customer can provide requirements for the data integration. The Solution Architect can collaborate with the Customer to further determine the data integration requirements, and can design a data integration pipeline based on said requirements. A Data Analyst can develop a S2T mapping. A Data Engineer can develop any new software, when needed, for the solution. A Project Manager can manage the teams. A Data Quality Specialist can specify the DQ rules (using DEAL, for example). A DevOps (or DataOps) Specialist can manage IT operations for the data integration job, and can enhance the infrastructure and the integration system (including automating, for example, parts of creating the PMD). An Ops-App Manager can support the operations of the data integration system.

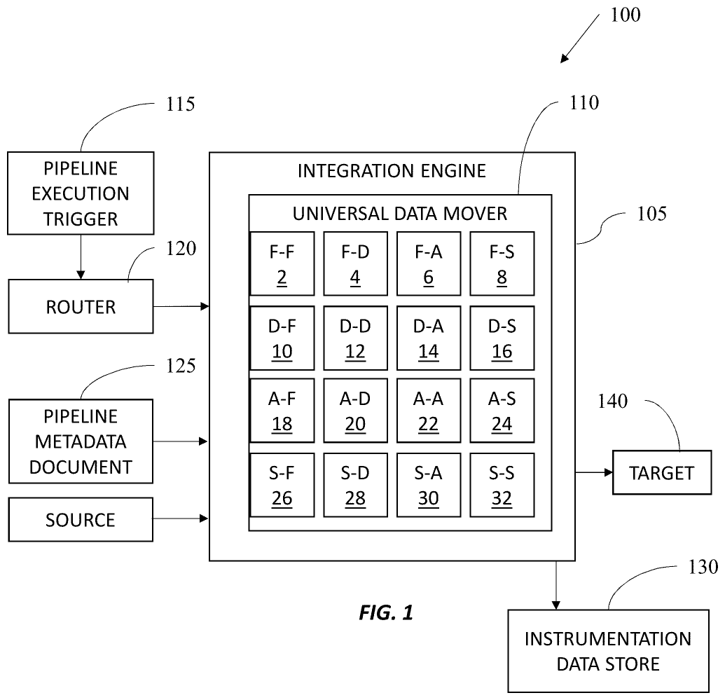

FIG. 1 is a block diagram of data integration system 100 in accordance with one embodiment of the invention. Data integration system 100 can include data integration engine 105 having Universal Data Mover (UDM) 110. UDM 100 can include a set of pipeline templates 2-32. Each of the pipeline templates 2-32 is configured to advantageously facilitate a data integration from a give Source type to a given Target type. Thus, pipeline templates 2-32 respectively facilitate data integration from File to File (pipeline template 2), File to Database (pipeline template 4), File to API (pipeline template 6), File to Stream (pipeline template 8), Database to File (pipeline template 10), Database to Database (pipeline template 12), Database to API (pipeline template 14), Database to Stream (pipeline template 16), API to File (pipeline template 18), API to Database (pipeline template 20), API to API (pipeline template 22), API to Stream (pipeline template 24), Stream to File (pipeline template 26), Stream to Database (pipeline template 28), Stream to API (pipeline template 30), and Stream to Stream (pipeline template 32).

In one embodiment, data integration system 100 can include pipeline execution trigger 115 in communication with router 120, which router 120 is in communication with integration engine 105. Router 120 can be a component configured to receive (or detect) a signal from pipeline execution trigger 115. Based at least in part on information associated with said signal, router 120 can determine which of pipeline templates 2-32 is to be executed by integration engine 105. In some embodiments, data integration system 100 can include pipeline metadata document (PMD) 125 in communication with integration engine 105. PMD 125 can include, among other things, data associated with behaviors of templates 2-32. In certain embodiments, data integration system 100 can include instrumentation data store 130, Source 135, and Target 140 in communication with integration engine 105. Instrumentation data store 130 can be used to store data associated with monitoring the execution of a pipeline template 2-32 by integration engine 105. Such data can include, for example, start time, end time, and/or errors produced during execution of a pipeline template 2-32.

In operation of data integration system 100, in one embodiment, router 120 receives a signal from pipeline execution trigger 115. Router 120 selects a pipeline template 2-32 from UDM 110 for execution by integration engine 105. At run time (that is, upon retrieval of a pipeline template 2-32 for execution), PMD 125 is retrieved and, based at least in part on data contained in PMD 125, the properties of the behaviors associated with the selected pipeline template 2-32 are set. Integration engine 105 continues execution of the selected pipeline template 2-32 for moving a data resource from Source 135 to Target 140. During execution of the selected pipeline template 2-32 metrics such as start time, end time, and errors can be stored in instrumentation data store 130.

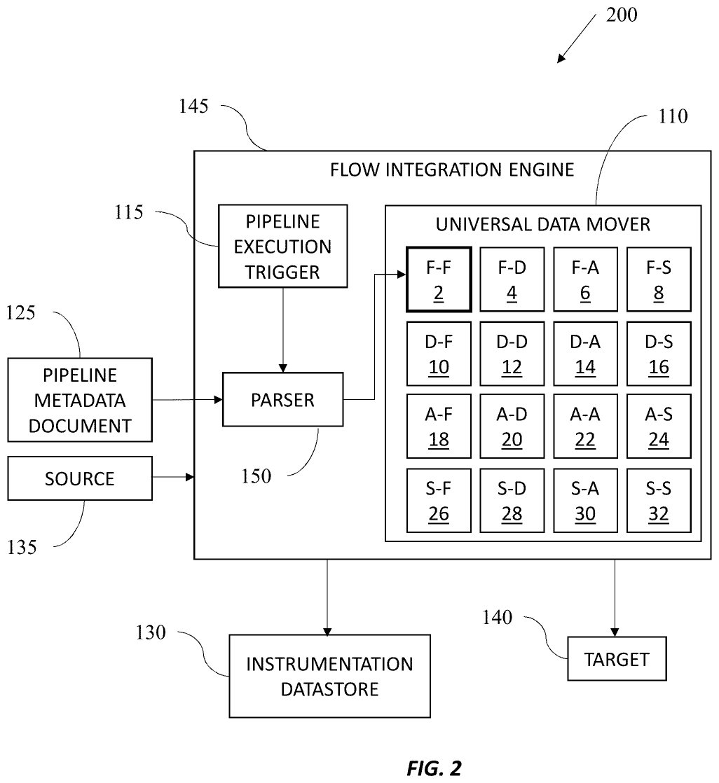

FIG. 2 is a block diagram of data integration system 200 in accordance with another embodiment of the invention. Data integration system 200 can include flow integration engine 145 having Universal Data Mover (UDM) 110. UDM 100 can include the set of pipeline templates 2-32. In one embodiment, flow integration engine 145 can include pipeline execution trigger 115 in communication with parser 150, which parser 150 is in communication with UDM 110. Parser 150 can be a component configured to receive (or detect) and parse a signal from pipeline execution trigger 115. Based at least in part on information associated with said signal, parser 150 can direct the sequence to a pipeline template 2-32 already running in flow integration engine 145. In the example illustrated in FIG. 2, the pipeline template File to File 2 is the pipeline template being executed by flow integration engine 145; hence, parser 150 directs the sequence to pipeline template File to File 2. In some embodiments, data integration system 200 can include pipeline metadata document (PMD) 125 in communication with parser 150. In certain embodiments, data integration system 200 can include instrumentation data store 130, Source 135, and Target 140 in communication with flow integration engine 145.

In operation of data integration system 200, in one embodiment, parser 150 receives a signal from pipeline execution trigger 115. Parser 150 retrieves and parses PMD 125 and then directs the sequence to a running pipeline template 2, for example. At run time (that is, upon retrieval and parsing of PMD 125 by parser 150), based at least in part on data contained in PMD 125, the properties of the behaviors associated with the running pipeline template 2 are set. Flow integration engine 145 continues execution of pipeline template 2 for moving a data resource from Source 135 to Target 140. During execution of pipeline template 2 metrics such as start time, end time, and errors can be stored in instrumentation data store 130. Run time begins when the pipeline execution engine is initiated or executed. RT=upon initializing the data pipeline through its finished execution. For external engine, inject the PMD during RT.

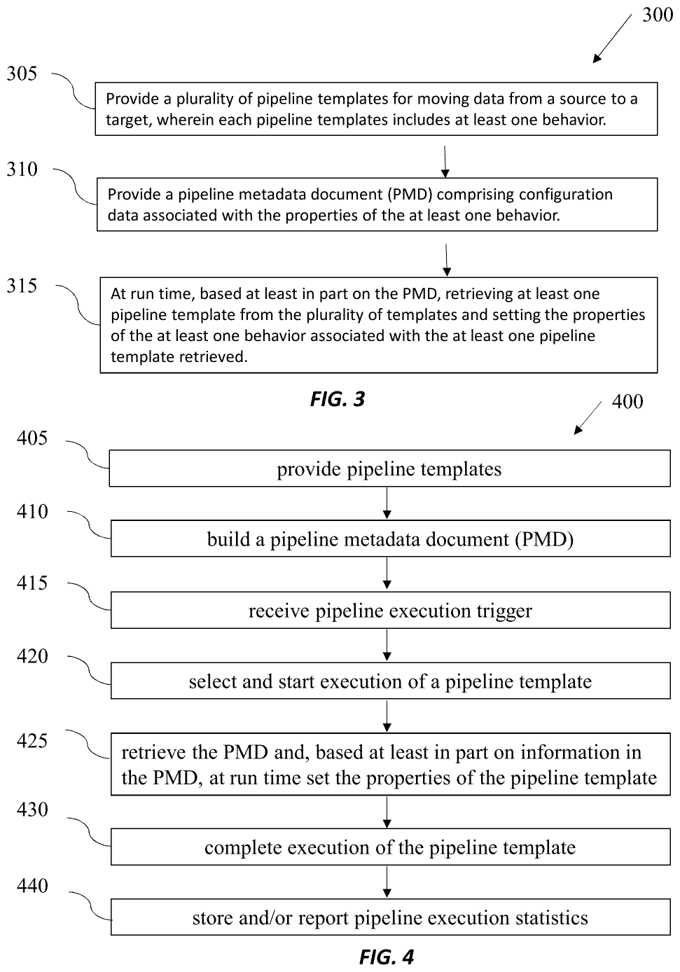

FIG. 3 is a flowchart illustrating a method of facilitating data integration. At a step 305, a plurality of pipeline templates (such as UDM 110 with pipeline templates 2-32) can be provided. Each of the pipeline templates includes at least one behavior. In some embodiments, the behavior is a standard behavior governed by the governance rules predetermined by an organization in order to provide standardization across multiple data integration pipelines and/or data integration teams. At a step 310, PMD 125 can be provided. PMD 125 can include configuration data associated with the properties of the behaviors of the pipeline templates 2-32. At a step 315, at run time (upon receiving a signal from pipeline execution trigger 115), based at least in part on the configuration data included in PMD 125, retrieving a pipeline template 2-32 and setting the properties of the behaviors associated with the retrieved pipeline template 2-32.

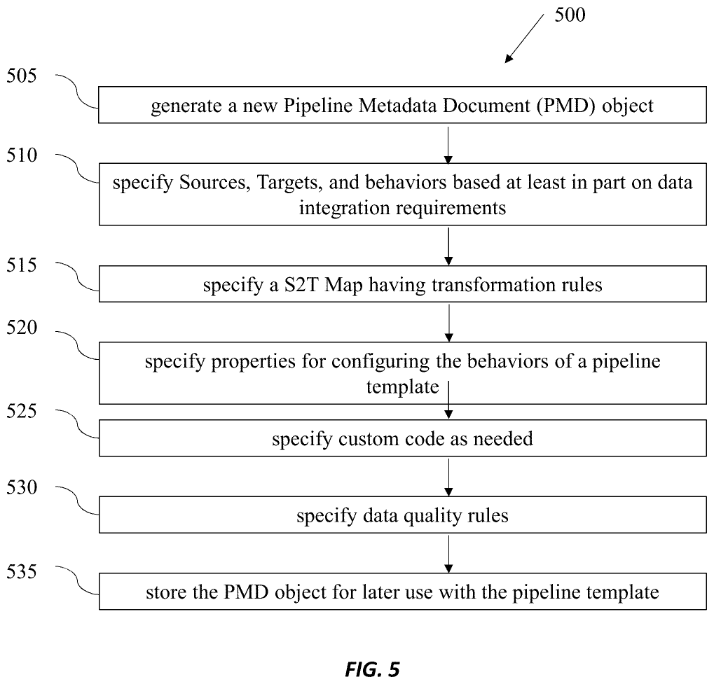

FIG. 4 is a flowchart illustrating another method of facilitating data integration. At a step 405, a set of pipeline templates (such as UDM 110 with pipeline templates 2-32) can be provided. At a step 410, PMD 125 can be built according to, for example, the method of FIG. 5. PMD 125 preferably includes at least configuration data associated with setting the properties of behaviors of pipeline templates 2-32. At a step 415, a pipeline execution trigger is received. At a step 420, based at least in part on information associated with the pipeline execution trigger, a pipeline template 2-32 is selected and execution of the pipeline template 2-32 starts. At a step 425, at run time, PMD 125 is retrieved, and based at least in part on configuration data included in PMD 125 the properties of the behaviors of the selected pipeline template 2-32 are set. At a step 430, execution of the pipeline template 2-32 can be completed. At a step 435, pipeline execution statistics can be stored and/or reported.

FIG. 5 is a flowchart illustrating an exemplary method of building PMD 125. At a step 505, a new PMD 125 object can be generated to receive and store configuration data for behaviors associated with pipeline templates. At step 510, Sources, Targets, and behaviors are specified. In one embodiment, the Sources, Targets, and behaviors are specified based at least in part on data integration requirements provided by at least one role, such as a Solution Architect and/or a Customer. At step 515, a Source-to-Target (S2T) Map can be specified. In some embodiments, the S2T Map includes at least one or more transformation rules. At a step 520, properties for configuring the behaviors associated with one or more pipeline templates are specified. At a step 525, custom code desired can be specified. In one embodiment, the custom code is included in PDM 125. In certain embodiments, information for accessing the custom code can be provided. At a step 530, data quality rules can be specified. At a step 535, the PMD can be stored for later use in execution of at least one pipeline template 2-32.

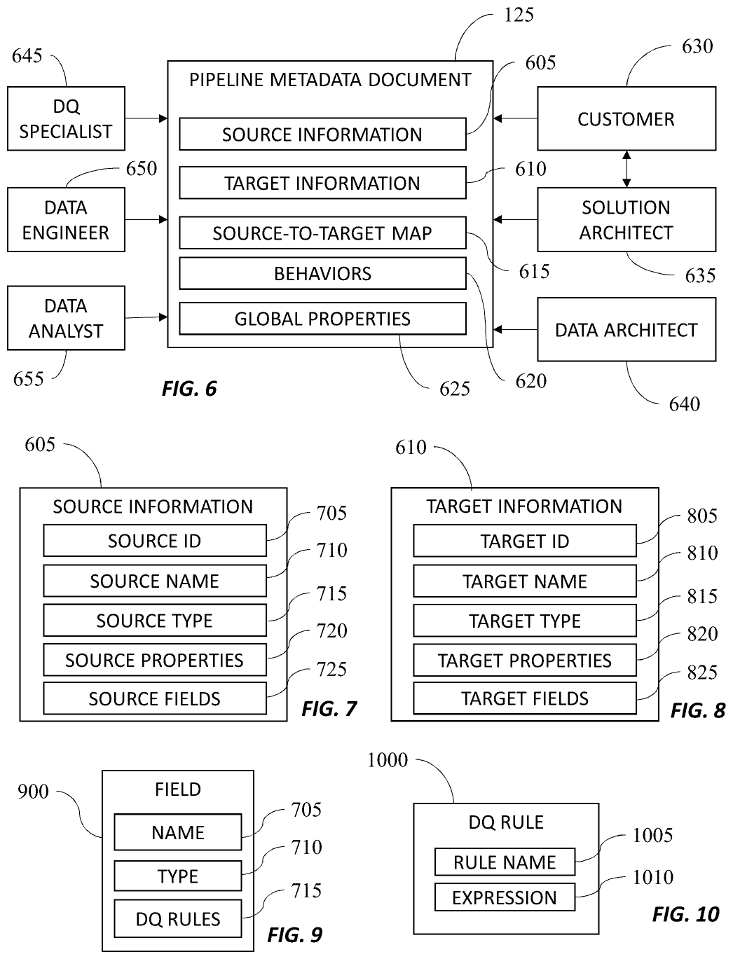

FIG. 6 is a block diagram illustrating certain aspects of an exemplary PMD 125. In one embodiment, PMD 125 can include Source Information 605, Target Information 610, Source-to-Target Map 615, Behaviors 620, and/or Global Properties 625. As illustrated in FIG. 6, in one embodiment PMD 125 can be built based at least in part on input from roles including at least one of Customer 630, Solution Architect 635, Data Architect 640, Data Analyst 645, Data Engineer 650, and DQ Specialist 655. In some embodiments, roles 630-655 are substantially automated; in other embodiments roles 630-655 are semi-automated (that is, involving some automated software components as well as some human input); in certain embodiments, at least one of roles 630-655 are substantially manual (that is, requiring substantial human input via suitable user interfaces).

FIG. 7 is a block diagram illustrating exemplary Source Information 605 object that can be used with PMD 125. In one embodiment, Source Information 605 can include Source ID 705, Source Name 710, Source Type 715, Source Properties 720, and/or Source Fields 725. Source Type 715 can be one of, for example, File, Database, API, and Stream. Source Properties 720 can be an object having at least one NAME:VALUE property specification associated with, for example, Source 135. Source Fields 725 can be fields of a data resource associated with Source 135.

FIG. 8 is a block diagram illustrating exemplary Target Information 610 object that can be used with PMD 125. In one embodiment, Target Information 610 can include Target ID 805, Target Name 810, Target Type 815, Target Properties 820, and/or Target Fields 825. Target Type 815 can be one of, for example, File, Database, API, and Stream. Target Properties 820 can be an object having at least one NAME:VALUE property specification associated with, for example, Target 140. Target Fields 825 can be fields of a schema associated with Target 140.

FIG. 9 is a block diagram illustrating an exemplary Field 900 object that can be used with Source Information 605 and/or Target Information 610. Field 900 can be used as Source Field 725 or Target Field 825. In one embodiment, Field 900 can include Name 905, Type 910, and DQ Rules 915. In one embodiment, Type 910 can be one of, for example, String, Integer, Double, Decimal, Boolean, Date, and DateTime. DQ Rules 915 can be a list object associated with at least one data quality rule. FIG. 10 is a block diagram illustrating exemplary DQ Rule 1000. In one embodiment, DQ Rule 1000 can include rule name 1005 and expression 1010. In some embodiments, expression 1010 can be an expression such as LEN(fieldname)<25 for ensuring data quality.

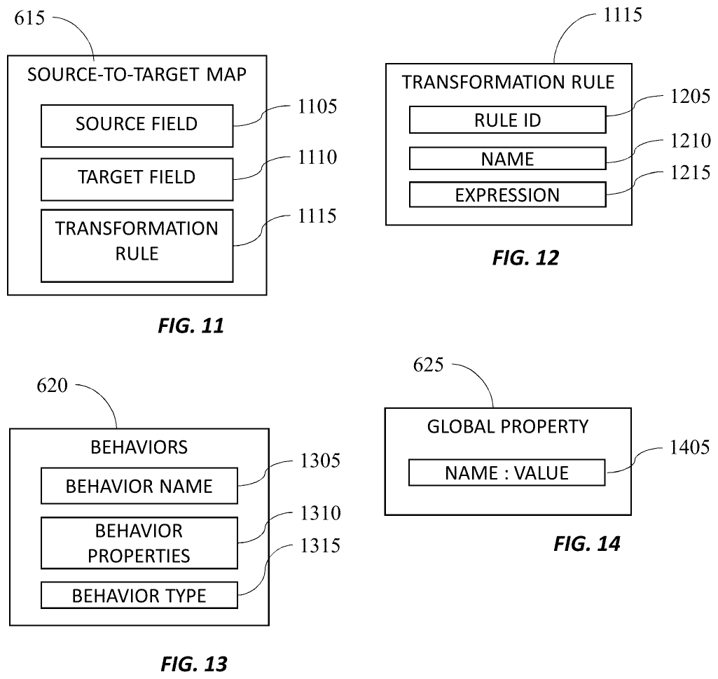

FIG. 11 is a block diagram of exemplary Source-to-Target (S2T) Map 615 that can be used with PMD 125. In one embodiment S2T Map 165 can include Source Field 1105, Target Field 1110, and Transformation Rule 1115. Source Field 1105 is associated with a field in the data resource of Source 135. Target Field 1110 is associated with a field in Target 140. Typically, Source Field 1105 correspond to Target Field 1110 (that is, the data associated with Source Field 1105 is to be extracted, transformed, and loaded to Target Field 1110. FIG. 12 is a block diagram of exemplary Transformation Rule 1115. In some embodiments, Transformation Rule 1115 can include Rule ID 1205, Transformation Rule Name 1210, and Transformation Rule Expression 1215. In one embodiment, Transformation Rule Expression 1215 can be an expression indicative of how the data in Source Field 1105 is to be transformed before being transmitted to Target Field 1110. One example of Transformation Rule 1115 is CONCATENATE(fieldA, fieldB).

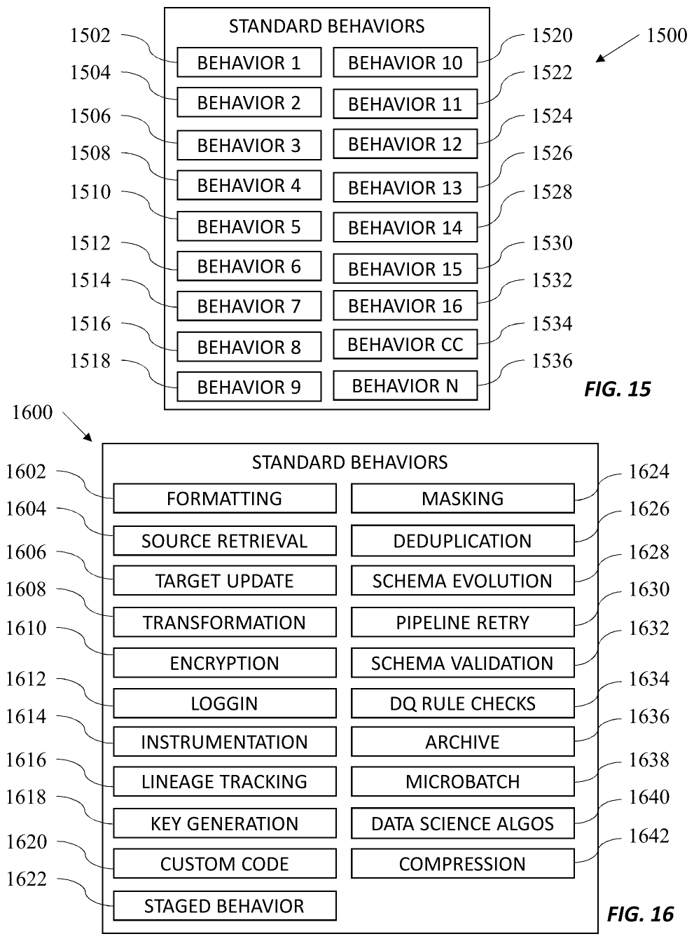

FIG. 13 is a block diagram illustrating exemplary Behaviors 620 object that can be used with PMD 125. In one embodiment, Behaviors 620 can be an array associated with one or more behaviors (see FIG. 15 and FIG. 16). In some embodiments, each behavior item listed in Behaviors 620 array can include Behavior Name 1305, Behavior Properties 1310, and Behavior Type 1315.

FIG. 15 is a block diagram illustrating exemplary Standard Behaviors 1500 that can be used with data integration system 100, and more specifically Standard Behaviors 1500 can be used in conjunction with PMD 125. In one embodiment, an organization (via, for example, a Data Governance Officer role or similar) can predefine a set of Standard Behaviors 1500 including Behaviors 1502-1356. In some embodiments, Behavior CC 1534 can be configured to facilitate use of custom code with data integration system 100.

FIG. 16 is a block diagram illustrating another exemplary Standard Behaviors 1600 that can be used in conjunction with PMD 125. In one embodiment, Standard Behaviors 1600 can include Behaviors 1502-1356. In some embodiments, Standard Behaviors 1600 can include Formatting 1602, Source Retrieval 1604, Target Update 1606, Transformation 1608, Encryption 1610, Loggin 1612, Instrumentation 1614, Lineage Tracking 1616, Key Generation 1618, Custom Code 1620, Staged Behavior 1622, Masking 1624, Deduplication 1626, Schema Evolution 1628, Pipeline Retry 1630, Schema Validation 1632, DQ Rule Checks 1634, Archive 1636, Microbatch 1638, Data Science Algorithms 1640, and/or Compression 1642. In other embodiments, Standard Behaviors 1600 can include fewer, or additional, behaviors other than those illustrated in FIG. 16.

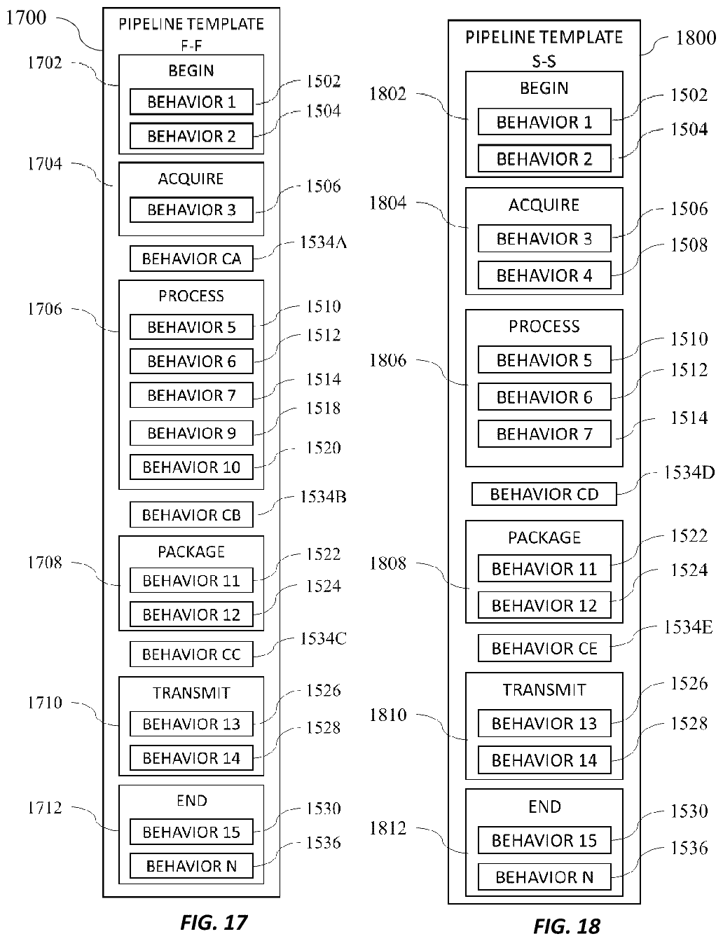

In one embodiment, Staged Behavior 1622 can include an association with one or more Begin, Acquire, Process, Package, Transmit, and End (BAPPTE) stages. In embodiments where BAPPTE stages are used (see FIG. 17 and FIG. 18), Staged Behavior 1622 can be performed during the associated BAPPTE stage.

FIG. 17 is a block diagram of exemplary pipeline template F-F 1700 for FILE-to-FILE data integration using BAPPTE stages. In one embodiment, pipeline template F-F 1700 can include stages Begin 1702, Acquire 1704, Process 1706, Package 1708, Transmit 1710, and/or End 1712. In some embodiments, Begin 1702 can include behavior 1 1502 and behavior 2 1504, for example. Acquire can include behavior 3 1506. In certain embodiments, pipeline template F-F 1700 can include behavior CA 1534A that is associated with custom code execution after stage Acquire 1704. Pipeline template F-F 1700 can include stage Process 1706 having, for example, behavior 5 1510, behavior 6 1512, behavior 7 1514, behavior 9 1518, and/or behavior 10 1520. Pipeline template F-F 1700 can include behavior CB 1534B that is associated with custom code execution after stage Process 1706. Package 1708 can include behavior 11 1522 and behavior 12 1524. Pipeline template F-F 1700 can include behavior CC 1534C that is associated with custom code execution after stage Package 1708. Transmit 1710 can include behavior 13 1526 and behavior 14 1528. End 1712 can include behavior 15 1530 and behavior N 1536. In a given embodiment, pipeline template F-F 1700 can include any Standard Behaviors 1600, for example, associated with a BAPPTE stage 1702-1712 of pipeline template F-F

FIG. 18 is a block diagram of exemplary pipeline template S-S 1800 for STREAM-to-STREAM data integration using BAPPTE stages. In one embodiment, pipeline template S-S 1800 can include stages Begin 1802, Acquire 1804, Process 1806, Package 1808, Transmit 1810, and/or End 1812. In some embodiments, Begin 1802 can include behavior 1 1502 and behavior 2 1504, for example. Acquire can include behavior 3 1506 and behavior 4 1508. Pipeline template S-S 1800 can include stage Process 1806 having, for example, behavior 5 1510, behavior 6 1512, and/or behavior 7 1514. Pipeline template S-S 1800 can include behavior CD 1534D that is associated with custom code execution after stage Process 1806. Package 1808 can include behavior 11 1522 and behavior 12 1524. Pipeline template S-S 1800 can include behavior CE 1534E that is associated with custom code execution after stage Package 1808. Transmit 1810 can include behavior 13 1526 and behavior 14 1528. End 1712 can include behavior 15 1530 and behavior N 1536. In a given embodiment, pipeline template S-S 1800 can include any Standard Behaviors 1600, for example, associated with a BAPPTE stage 1802-1812 of pipeline template S-S 1800.

Pipeline template F-F 1700 and pipeline template S-S 1800 are illustrative. Similar templates can be built for pipeline templates 2-32 of UDM 110. The number of Standard Behaviors 1500 or Standard Behaviors 1600 included in stages BAPPTE of a given pipeline template can be the same, more, or less than that illustrated in FIG. 17 and FIG. 18.

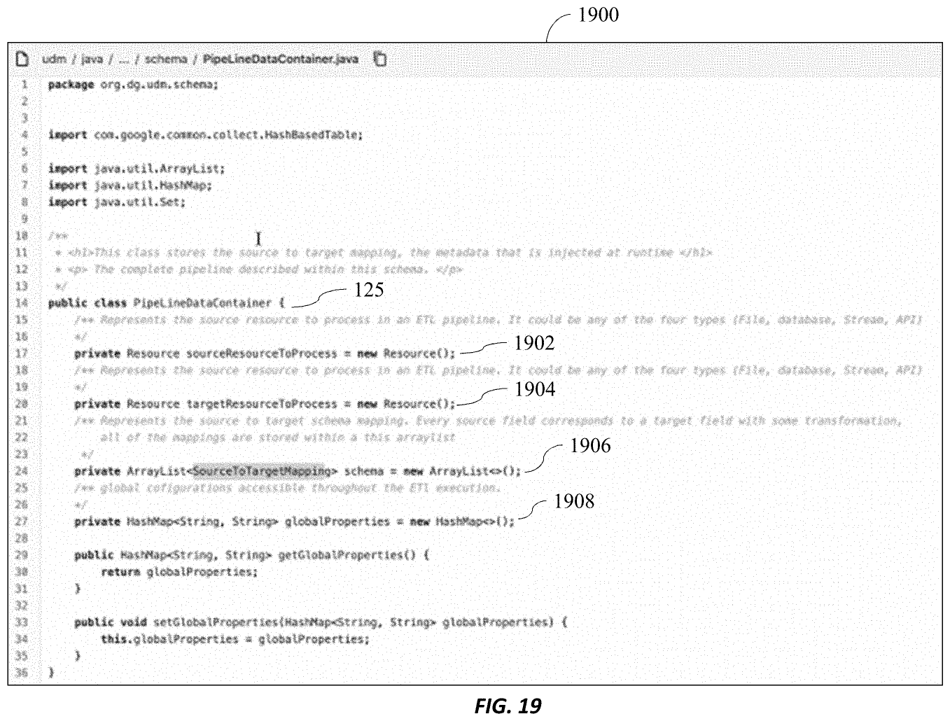

FIG. 19 is an illustration of exemplary PMD source code 1900 that can be used to facilitate building PMD 125. In one embodiment, PMD source code 1900 can include code for creating: (a) Source Object 1902, which Source Object 1902 can include data and/or instructions associated with Source 135; (b) Target Object 1904, which Target Object 1904 can include data and/or instructions associated with Target 140; (c) Source-to-Target Map Object 1906, which Source-to-Target Map Object 1906 can include data and/or instructions associated with, for example, Source Fields 1105, Target Fields 1110 and/or Transformation Rules 1115 (see FIG. 11); and (d) Global Properties Object 1908, which Global Properties Object 1908 can include properties associated with a given data pipeline.

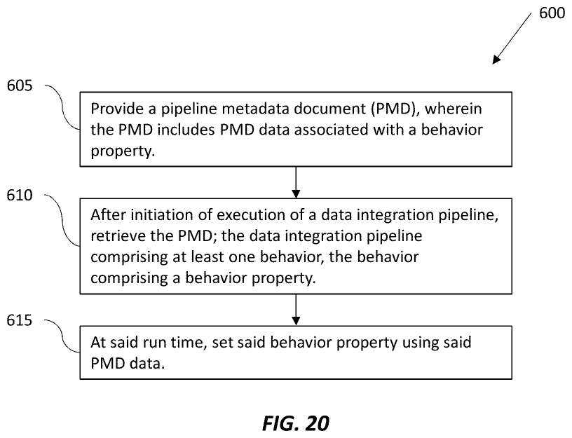

FIG. 20 is a flowchart of an illustrative method of data integration 600 according to one embodiment of the invention. At a step 605, a pipeline metadata document (PMD) can be provided. The PMD includes data associated with at least one behavior of a data integration pipeline. At step 610, after initiation of the execution of the data integration pipeline, the PMD can be retrieved (from, for example, a PMD repository). The data integration pipeline can have one or more behaviors, and at least some of the behaviors can have properties that can be set during execution of the data integration pipeline. At a step 615, during execution of the data integration pipeline, the properties of the behavior are set based on the associated data included in the PMD.

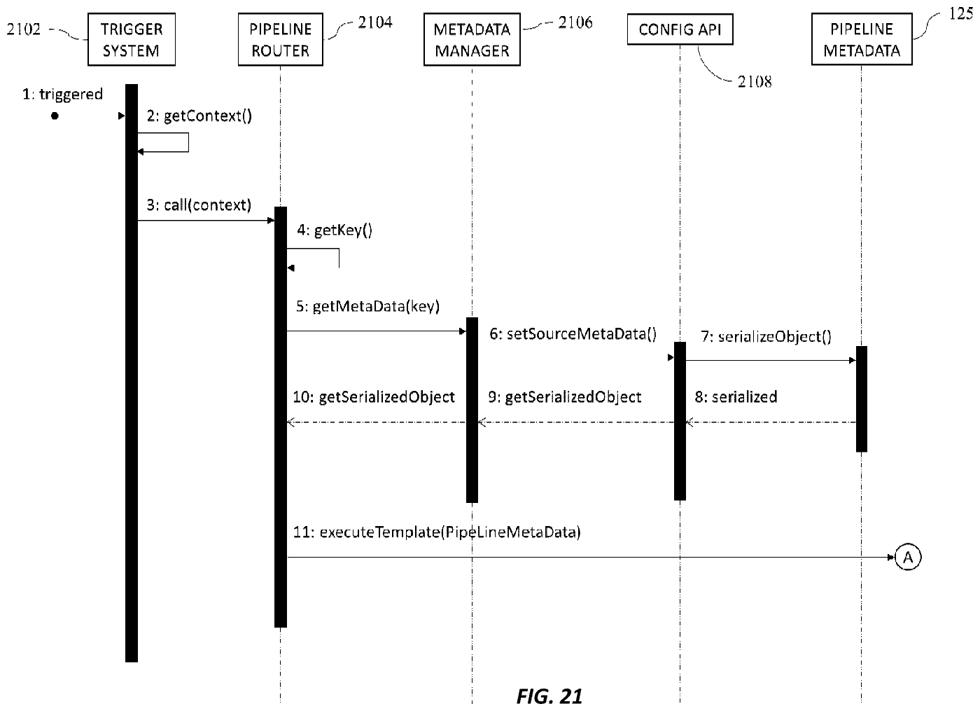

FIG. 21 is a sequence diagram illustrating a method of data integration according to some embodiments of the invention. At 1 Trigger System 2102 receives and/or detects a signal. At 2 Trigger System 2102 gets Context data from the signal. At 3 Trigger System 2102 makes a call to Pipeline Router 2104 and provides Context as input. At 4 Pipeline Router 2104 gets a key associated with a given PMD 125. At 5 Pipeline Router 2104 sends the key to Metadata Manager 2106 and requests PMD 125 from Metadata Manager 2106. At 6 Metadata Manager 2106 requests PMD 125 from Configuration API 2108 and sets the metadata associated with Source 135. At 7 Configuration API requests serialized object from Pipeline Metadata 125. At 8 Pipeline Metadata 125 returns serialized object to Configuration API 2108. At 9 Configuration API 2108 returns serialized object to Metadata Manager 2106. At 10 Metadata Manager 2106 returns serialized object to Pipeline Router 2104.

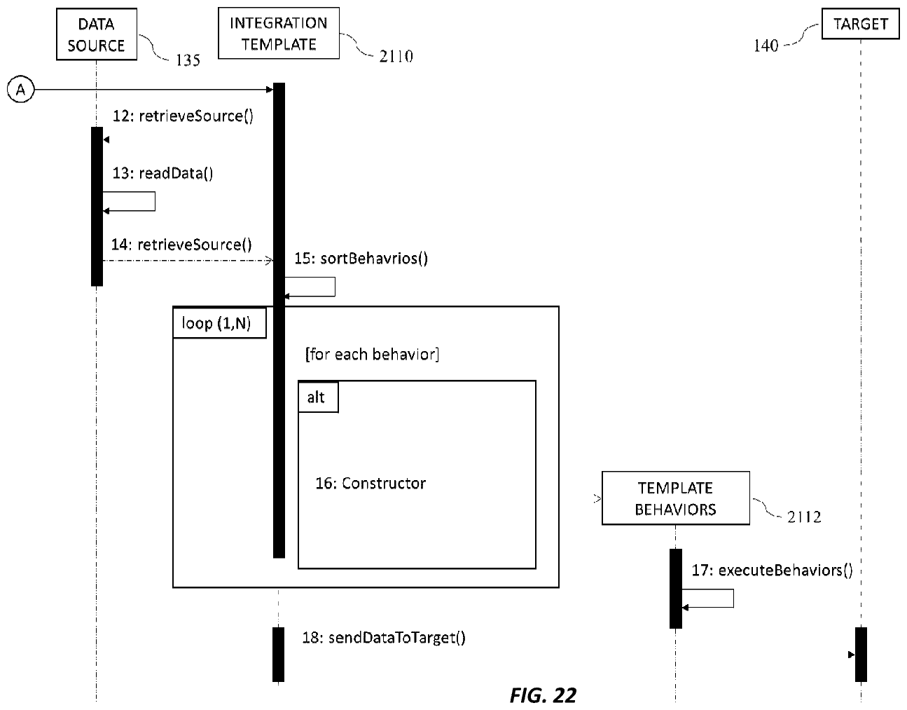

At 11 Pipeline Router 2104 starts execution of a pipeline template based, at least in part, on data provided in PMD 125. Referencing FIG. 22 now, at 12 Integration Template 2110 access a data resource associated with Data Source 135. At 13 Data Source 135 reads the data to be accessed or that is requested by Integration Template 2110. At 14 Data Source 135 forwards the data to Integration Template 2110. At 15 Integration Template 2110 sorts the behaviors associated with the pipeline template selected at 11 by Pipeline Router 2104. At 16 Integration Template 2110 loops through each behavior in the pipeline template. Integration Template 2110 forwards PMD 125 data associated with properties of behaviors to Template Behaviors 2112. At 17 Template Behaviors 2112 executes the behavior based on the properties provided by Constructor at 16. At 18 Integration Template 2110 transmits the transformed data to Target 140.

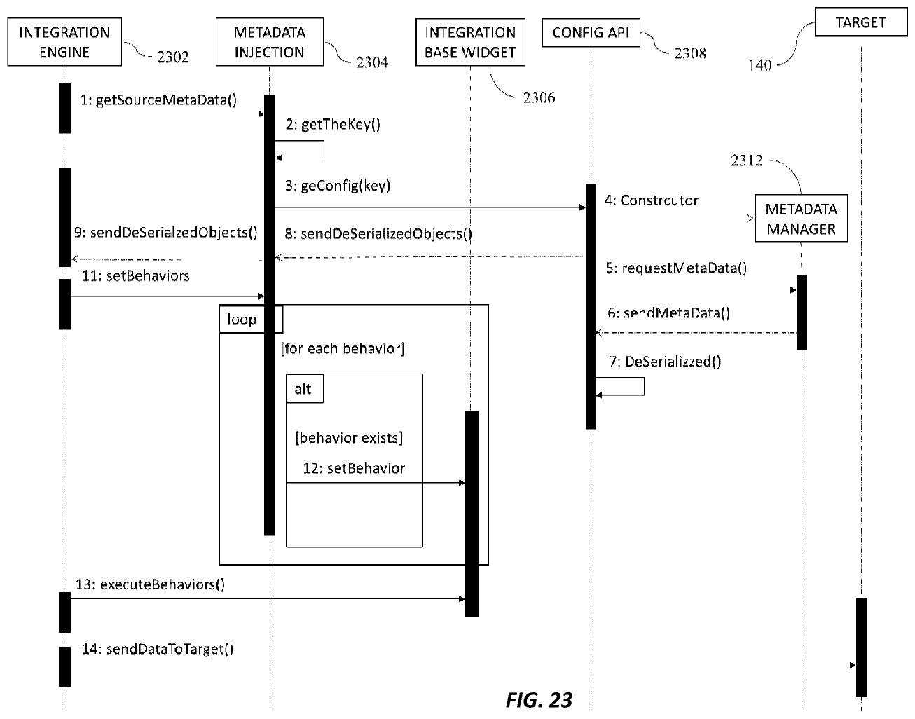

FIG. 23 is a sequence diagram illustrating a method of data integration in accordance with certain embodiments of the invention. At 1 Integration Engine 2302 gets the source metadata. At 2 Metadata Injection 2304 component gets the key, and at 3 Metadata Injection 2304 requests configuration data from Configuration API 2308. At 4 Configuration API 2308 sends Constructor to Metadata Manager 2312, and at 5 Configuration API 2308 sends metadata request to Metadata Manager 2312. At 6 Metadata Manager 2312 sends PMD 125 to Configuration API 2308. At 7 Configuration API 2308 deserializes PMD 125. At 8 Configuration API 2308 sends the deserialized PMD 125 to Metadata Injection 2304, and at 9 Metadata Injection 2304 sends the deserialized PMD 125 to Integration Engine 2302. At 11 Integration Engine 2302 requests Metadata Injection to set the properties of the behaviors. At 12, for each behavior Metadata Injection 2304 sets the properties associated with the behavior. At 13 Integration Engine 2302 executes the behaviors with Integration Base Widget 2306. At 14 Integration Engine 2302 transmits the transformed data to Target 140.

The disclosed technologies may be implemented on one or more computing devices. Such a computing device may be implemented in various forms including, but not limited to, a client, a server, a network device, a mobile device, a cell phone, a smart phone, a laptop computer, a desktop computer, a workstation computer, a personal digital assistant, a blade server, a mainframe computer, and other types of computers. The computing device described below and its components, including their connections, relationships, and functions, is meant to be exemplary only, and not meant to limit implementations of the disclosed technologies described in this specification. Other computing devices suitable for implementing the disclosed technologies may have different components, including components with different connections, relationships, and functions.

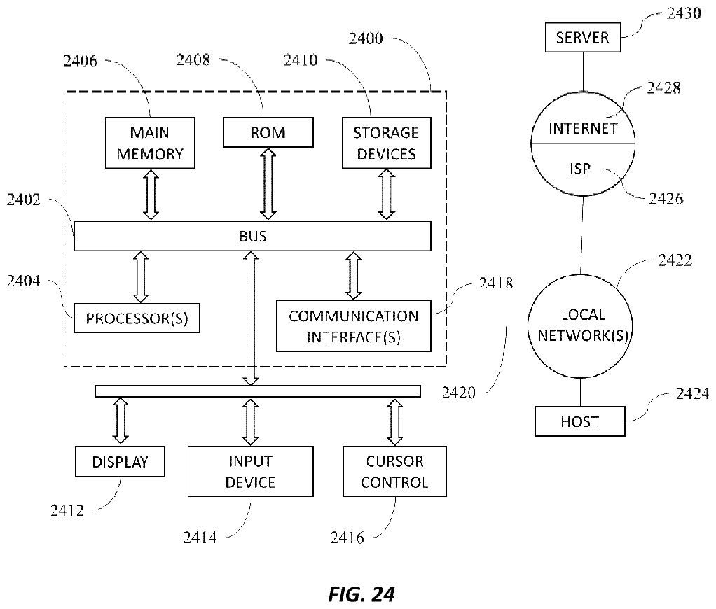

FIG. 24 is a block diagram that illustrates an example of a computing device 2400 suitable for implementing the disclosed technologies. Computing device 2400 includes bus 2402 or other communication mechanism for addressing main memory 2406 and for transferring data between and among the various components of device 2400. Computing device 2400 also includes one or more hardware processors 2404 coupled with bus 2402 for processing information. A hardware processor 2404 may be a general purpose microprocessor, a system on a chip (SoC), or other processor suitable for implementing the described technologies.

Main memory 2406, such as a random access memory (RAM) or other dynamic storage device, is coupled to bus 2402 for storing information and instructions to be executed by processor(s) 2404. Main memory 2406 also may be used for storing temporary variables or other intermediate information during execution of instructions to be executed by processor(s) 2404. Such instructions, when stored in non-transitory storage media accessible to processor(s) 2404, render computing device 2400 into a special-purpose computing device that is customized to perform the operations specified in the instructions.

Computing device 2400 further includes read only memory (ROM) 2408 or other static storage device coupled to bus 2402 for storing static information and instructions for processor(s) 2404.

One or more mass storage devices 2410 are coupled to bus 2402 for persistently storing information and instructions on fixed or removable media, such as magnetic, optical, solid-state, magnetic-optical, flash memory, or any other available mass storage technology. The mass storage may be shared on a network, or it may be dedicated mass storage. Typically, at least one of the mass storage devices 2410 (e.g., the main hard disk for the device) stores a body of program and data for directing operation of the computing device, including an operating system, user application programs, driver and other support files, as well as other data files of all sorts.

Computing device 2400 may be coupled via bus 2402 to display 2412, such as a liquid crystal display (LCD) or other electronic visual display, for displaying information to a computer user. Display 2412 may also be a touch-sensitive display for communicating touch gesture (e.g., finger or stylus) input to processor(s) 2404. An input device 2414, including alphanumeric and other keys, is coupled to bus 2402 for communicating information and command selections to processor 2404. Another type of user input device is cursor control 2416, such as a mouse, a trackball, or cursor direction keys for communicating direction information and command selections to processor 2404 and for controlling cursor movement on display 2412. This input device typically has two degrees of freedom in two axes, a first axis (e.g., x) and a second axis (e.g., y), that allows the device to specify positions in a plane.

Computing device 2400 may implement the methods described herein using customized hard-wired logic, one or more application-specific integrated circuits (ASICs), one or more field-programmable gate arrays (FPGAs), firmware, or program logic which, in combination with the computing device, causes or programs computing device 2400 to be a special-purpose machine.

Methods disclosed herein may also be performed by computing device 2400 in response to processor(s) 2404 executing one or more sequences of one or more instructions contained in main memory 2406. Such instructions may be read into main memory 2406 from another storage medium, such as storage device(s) 2410. Execution of the sequences of instructions contained in main memory 2406 causes processor(s) 2404 to perform the process steps described herein. In alternative embodiments, hard-wired circuitry may be used in place of or in combination with software instructions.

The term “storage media” as used herein refers to any non-transitory media that store data and/or instructions that cause a computing device to operate in a specific fashion. Such storage media may comprise non-volatile media and/or volatile media. Non-volatile media includes, for example, optical disks, magnetic disks, or solid-state drives, such as storage device 2410. Volatile media includes dynamic memory, such as main memory 2406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 2402. Transmission media can also take the form of acoustic or light waves, such as those generated during radio-wave and infra-red data communications.

Various forms of media may be involved in carrying one or more sequences of one or more instructions to processor(s) 2404 for execution. For example, the instructions may initially be carried on a magnetic disk or solid-state drive of a remote computer. The remote computer can load the instructions into its dynamic memory and send the instructions over a telephone line using a modem. A modem local to computing device 2400 can receive the data on the telephone line and use an infra-red transmitter to convert the data to an infra-red signal. An infra-red detector can receive the data carried in the infra-red signal and appropriate circuitry can place the data on bus 2402. Bus 2402 carries the data to main memory 2406, from which processor(s) 2404 retrieves and executes the instructions. The instructions received by main memory 2406 may optionally be stored on storage device(s) 2410 either before or after execution by processor(s) 2404.

Computing device 2400 also includes one or more communication interface(s) 2418 coupled to bus 2402. A communication interface 2418 provides a two-way data communication coupling to a wired or wireless network link 2420 that is connected to a local network 2422 (e.g., Ethernet network, Wireless Local Area Network, cellular phone network, Bluetooth wireless network, or the like). Communication interface 2418 sends and receives electrical, electromagnetic, or optical signals that carry digital data streams representing various types of information. For example, communication interface 2418 may be a wired network interface card, a wireless network interface card with an integrated radio antenna, or a modem (e.g., ISDN, DSL, or cable modem).

Network link(s) 2420 typically provide data communication through one or more networks to other data devices. For example, a network link 2420 may provide a connection through a local network 2422 to a host computer 2424 or to data equipment operated by an Internet Service Provider (ISP) 2426. ISP 2426 in turn provides data communication services through the world wide packet data communication network now commonly referred to as the “Internet” 2428. Local network(s) 2422 and Internet 2428 use electrical, electromagnetic or optical signals that carry digital data streams. The signals through the various networks and the signals on network link(s) 2420 and through communication interface(s) 2418, which carry the digital data to and from computing device 2400, are example forms of transmission media.

Computing device 2400 can send messages and receive data, including program code, through the network(s), network link(s) 2420 and communication interface(s) 2418. In the Internet example, a server 2430 might transmit a requested code for an application program through Internet 2428, ISP 2426, local network(s) 2422 and communication interface(s) 2418. The received code may be executed by processor 2404 as it is received, and/or stored in storage device 2410, or other non-volatile storage for later execution.

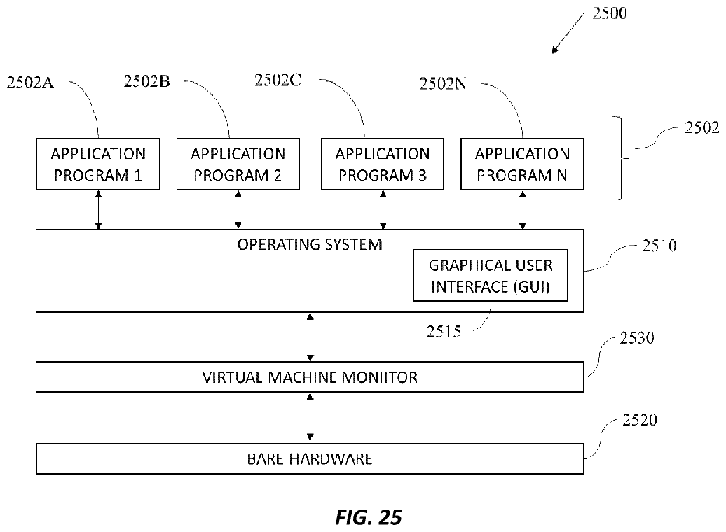

FIG. 25 is a block diagram of a software system for controlling the operation of computing device 2400. As shown, a computer software system 2500 is provided for directing the operation of the computing device 2400. Software system 2500, which is stored in system memory (RAM) 2406 and on fixed storage (e.g., hard disk) 2410, includes a kernel or operating system (OS) 2510. The OS 2510 manages low-level aspects of computer operation, including managing execution of processes, memory allocation, file input and output (I/O), and device I/O. One or more application programs, such as client application software or “programs” 2502 (e.g., 2502A, 2502B, 2502C . . . 2502N) may be “loaded” (i.e., transferred from fixed storage 2410 into memory 2406) for execution by the system 2500. The applications or other software intended for use on the device 2400 may also be stored as a set of downloadable computer-executable instructions, for example, for downloading and installation from an Internet location (e.g., Web server).

Software system 2500 may include a graphical user interface (GUI) 2515, for receiving user commands and data in a graphical (e.g., “point-and-click” or “touch gesture”) fashion. These inputs, in turn, may be acted upon by the system 2500 in accordance with instructions from operating system 2510 and/or client application module(s) 2502. The GUI 2515 also serves to display the results of operation from the OS 2510 and application(s) 2502, whereupon the user may supply additional inputs or terminate the session (e.g., log off).

The OS 2510 can execute directly on the bare hardware (e.g., processor(s) 2404) 2520 of device 2400. Alternatively, a hypervisor or virtual machine monitor (VMM) 2530 may be interposed between the bare hardware 2520 and the OS 2510. In this configuration, VMM 2530 acts as a software “cushion” or virtualization layer between the OS 2510 and the bare hardware 2520 of the device 2400.

VMM 2530 instantiates and runs virtual machine instances (“guest machines”). Each guest machine comprises a “guest” operating system, such as OS 2510, and one or more applications, such as applications 2502, designed to execute on the guest operating system. The VMM 2530 presents the guest operating systems with a virtual operating platform and manages the execution of the guest operating systems. In some instances, the VMM 2530 may allow a guest operating system to run as through it is running on the bare hardware 2520 of the device 2400 directly. In these instances, the same version of the guest operating system configured to execute on the bare hardware 2404 directly may also be able to execute on VMM 2530 without modification or reconfiguration. In other words, VMM 2530 may provide full hardware and CPU virtualization to a guest operating system in some instances. In other instances, a guest operating system may be specially designed or configured to execute on VMM 2530 for efficiency. In these instances, the guest operating system is “aware” that it executes on a virtual machine monitor. In other words, VMM 2530 may provide para-virtualization to a guest operating system in some instances.

The above-described computer hardware and software are presented for purpose of illustrating basic underlying computer components that may be employed for implementing the disclosed technologies. The disclosed technologies, however, are not limited to any particular computing environment or computing device configuration. Instead, the disclosed technologies may be implemented in any type of system architecture or processing environment capable of supporting the disclosed technologies presented in detail below. While the disclosed technologies may operate within a single standalone computing device (e.g., device 2400 of FIG. 24), the disclosed technologies may be implemented in a distributed computing environment.

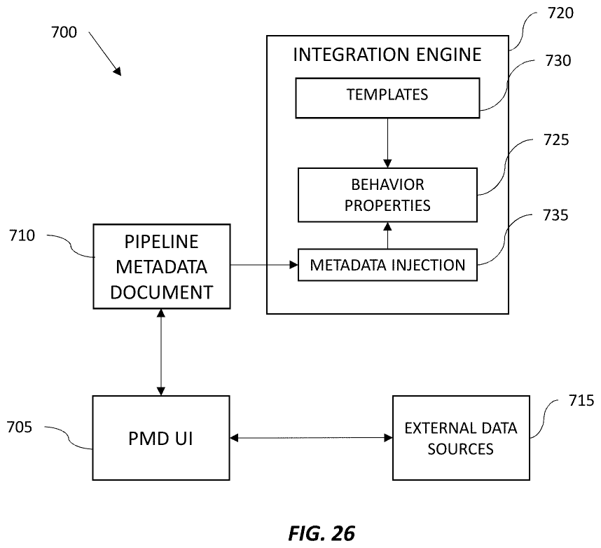

FIG. 26 is an illustration of one embodiment of data integration system 700. Data integration system 700 can include PMD user interface (PMD UI) 705 configured to facilitate the creation, retrieval, updating, and/or deleting of PMD 710. In some embodiments, PMD UI 705 can be configured to communicate with one or more external data sources 715 to facilitate, for example, the generation and/or updating of PMD 710. In one embodiment, data integration system 700 can include integration engine 720 configured to retrieve and use PMD 710 during execution of a data integration pipeline. In some embodiments, integration engine 720 includes, and is configured to execute, at least one behavior property 725. In certain embodiments, integration engine 720 can include at least one template 730, which template 730 can define behaviors and associated behavior properties. In one embodiment, integration engine 720 can include metadata injection component 730 configured to (a) retrieve PMD 710 after initiation of a data integration pipeline execution, and (b) set at least one behavior property 725 during execution of the data integration pipeline.

In operation, PMD UI 705 receives manual or automated input to generate PMD 710. In some embodiments, input to PMD UI 705 can include input from human users. In certain embodiments, input to PMD UI 705 can be provided through automation by configuring PMD UI 705 to automatically analyze and retrieve relevant data for PMD 710 from external data sources 715. External data sources 715 can include, for example, files, APIs, databases, streams/queues, and/or data catalogues. In the case of data catalogues, there is often a metadata document associated with the data; hence, such a document can be analyzed to obtain relevant data for PMD 710. In the case of a file, for example a .csv file, headers can be parsed for column names, data types can be inferred from data values; files in JSON, XML, YAML formats can be deduced to their name and value pairs. As for APIs, modern APIs typically return structured payloads that include attribute-values in a format that can be parsed. Almost all databases are configured to provide metadata about particular tables or document structures. In the case of Streams/queues, these often contain a schema to describe its metadata. In some embodiments, PMD UI 705 can be used to update PMD 710 dynamically during execution of a data integration pipeline. In certain embodiments, metadata injection component 735 can retrieve during execution of a data integration pipeline a dynamically updated PMD 710.

In some embodiments, at or after initiation of execution of a data integration pipeline, integration engine 720 can use templates 730 to configure behavior properties 725. In certain embodiments, after initiation of execution of a data integration pipeline, metadata injection component 735 retrieves PMD 710, and using data provided in PMD 710, metadata injection component 735 sets behavior properties 725. Integration engine 720 goes on execution of the data integration pipeline until the end of the data integration pipeline. In one embodiment, PMD 710 is stored in a PMD data container (not shown in FIG. 26); then, based on information provided during a trigger of execution of a data integration pipeline, metadata injection component 735 can retrieve PMD 710 from the PMD data container by, for example, a file name associated with PMD 710.

In some embodiments, templates 730 can be internal templates or external templates. Internal templates can be configured to process specific portions of FADS to other FADS. An internal template can be configured to, for example, control the ordering of processing, which staged behaviors to call, and/or which non-staged behaviors to implement. An external template that can be used with an external engine (defined below) can be a collection of components that aid in moving data from Source to Target in a coordinated workflow. These systems can include a visual designer where components are dropped on the screen. These components can contain properties that, when provided, set the exact behavior of the component. An example might be a file reader whose properties include path and file name. Another example of a component may be a Database Writer component whose properties can include connection information and table name to write to. A template could then be saved and run as a specific data pipeline in the external system. Embodiments of the inventive systems and methods disclosed here can facilitate not setting the properties prior to running them, but rather setting properties once the data integration system has detected the file was saved. An external engine can be a third-party product or framework that can also benefit from the embodiments of the inventive systems and methods disclosed here. An internal engine can be configured to embody any or all of the above components of a data integration engine described above; the internal engine can be custom built in any desired programming language and with any desired components.

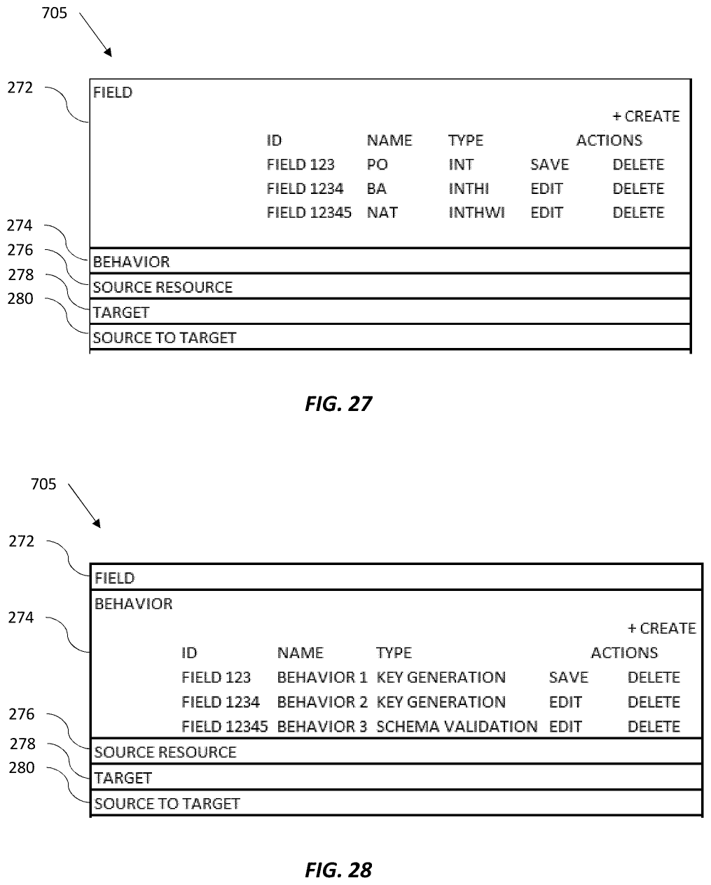

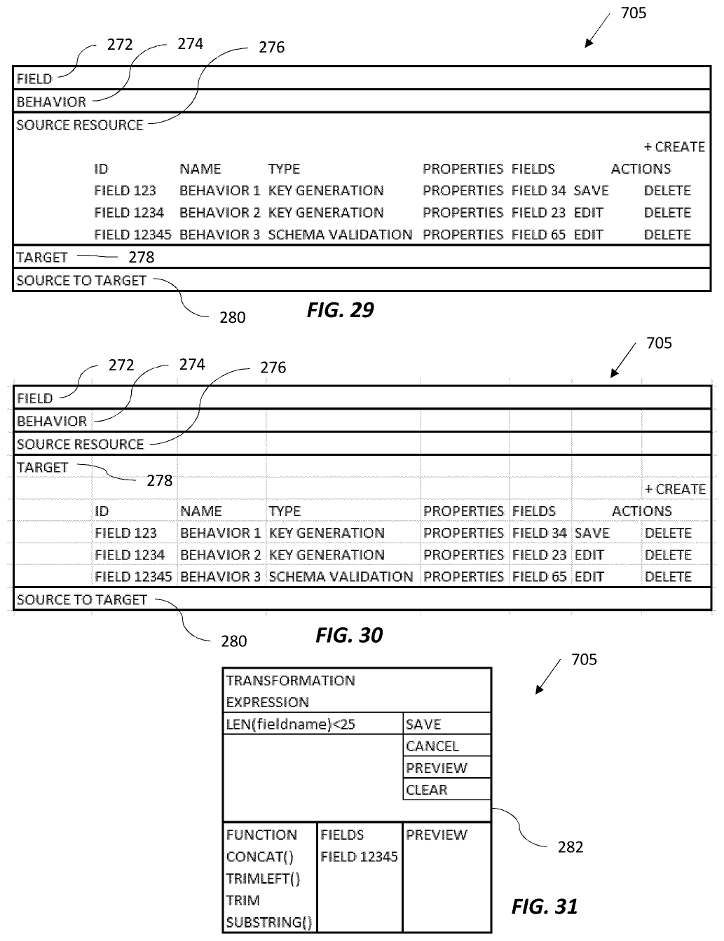

FIG. 27-31 illustrate one exemplary embodiment of PMD UI 705 that can be used with data integration system 700. PMD UI 705 can include field component 272 configured to facilitate creation, modification, saving, and/or deletion of fields. PMD UI 705 can include behavior component 274 configured to facilitate creation, modification, saving, and/or deletion of behaviors. PMD UI 705 can include source resource component 276 configured to facilitate creation, modification, saving, and/or deletion of data associated with sources. PMD UI 705 can include target resource component 278 configured to facilitate creation, modification, saving, and/or deletion of data associated with targets. PMD UI 705 can include source to target component 276 configured to facilitate creation, modification, saving, and/or deletion of, for example, transformations of a source-to-target mapping. FIG. 31 shows an exemplary transformation component 282 configured to facilitate creating, saving, and/or previewing transformations.

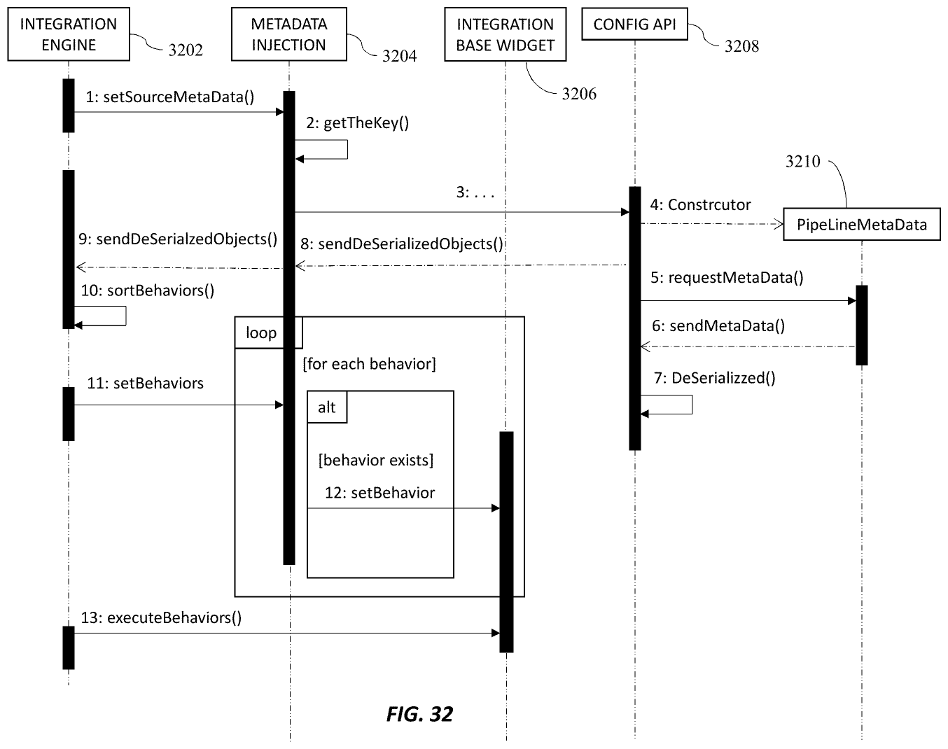

Referencing FIG. 32, in one embodiment, external integration engine 3202 is configured to execute a data integration pipeline by, for example, reading from a Source and performing transformations. In some embodiments, it is in external integration engine 3202—using the facilities of external integration engine 3202—that the data in a PMD can be injected into external engine's 3202 execution of the data integration pipeline. Techniques for the injection can vary across different tools. External data integration engine 3202 can be, for example, known ETL tools and/or data integration platforms.

In a scripting engine, external tools can provide components that call programming scripts in different languages. External tools can provide memory spaces to store properties associated with the external tools components. These components can be coordinated in a visual workflow. In some instances, a file watcher component can be provided that waits for a file to be created. If a PMD is going from a file source, the data integration pipeline can have the file name stored in a variable.

In some embodiments, a component in the workflow can be a scriptable component. In this script there can be instructions to: (a) retrieve the PMD for that file by passing the file name to a component to resolve that file name into a particular PMD; in one embodiment, this can be done by comparing the resource name in the PMD to the file name; (b) parse the PMD and store the PMD data in memory; for each Global Property in the PMD, look up a match for the same property of the data integration pipeline, and set the property in the external engine; for each behavior in the PMD, retrieve the Behavior Name from the PMD, and for each property in the behavior: look up a match for the same property of the data integration pipeline, and set the property in the external widget. The scripting engine can then execute the data integration pipeline with the properties for the data integration pipeline and its components having been set with the information provided in the PMD.

In some embodiments, external engine 3202 can include integration base widget 3206 with droppable or configurable set of components having properties. These properties can be set after retrieving and parsing the PMD after external integration engine 3202 initiates execution of the data integration pipeline.

In certain embodiments, an external engine can communicate with configuration API 3208, which can be an external interface called to retrieve the PMD. Configuration API 3208 can include get and set methods available via web services; and configuration API 3208 can be configured to deliver the PMD in different formats.

In one embodiment, external integration engine 3202 can use a repository that holds all the PMD documents. This repository can be a file system, relational database, or document database.

In some embodiments, external integration engine 3202 can include and/or access files specifying its own metadata schema (that is, its own PMD) that is understood by the external integration engine. This metadata can be structured and readable. In this case, the metadata file can be retrieved. The PMD property values can be used to set the values of the properties in the external integration engine's metadata file.

In certain embodiments, a data integration system can have a document template configured to facilitate templated substitutions in a structured manner with tags such as % filename %. The properties in such a document template can be set with the information provided in the PMD.

In one embodiment, external integration engine 3202 can detect the arrival of a resource or execute a data pipeline on a schedule. External integration engine 3202 executes the data integration pipeline according to the PMD upon a creation of a resource or upon a schedule.

In one embodiment, integration engine 3202 executes setSourceMetaData( ) [1], then metadata injection component 3204 gets the key [2: getTheKey( )]. Then metadata injection component calls config API 3208 [3: . . . ]. Config API 3208 executes Constructor [4] and execution continues at PipelineMetaData component 3210. Config API 3208 executes requestMetaData( ) [5]; PipelineMetaData 3210 executes sendMetaData( ) [6]; config API 3208 executes Deserialized [7]. Config API 3208 forwards [8: sendDeserializedObjects( )] deserialized PMD to meta data injection component 3204, which forwards [9: sendDeserializedObjects( )] the deserialized PMD to integration engine 3202. In some embodiments, integration engine 3202 is configured to sort behaviors [10: sortBehaviors( )]. In certain embodiments, integration engine 3202 in cooperation with meta data injection component 3204 sets each behavior [11: setBehaviors( ) and 12: setBehavior( )]. Integration engine 3202 can be configured to execute and/or cooperate with integration base widget 3206 to execute the data integration pipeline behaviors [13: execute behaviors].

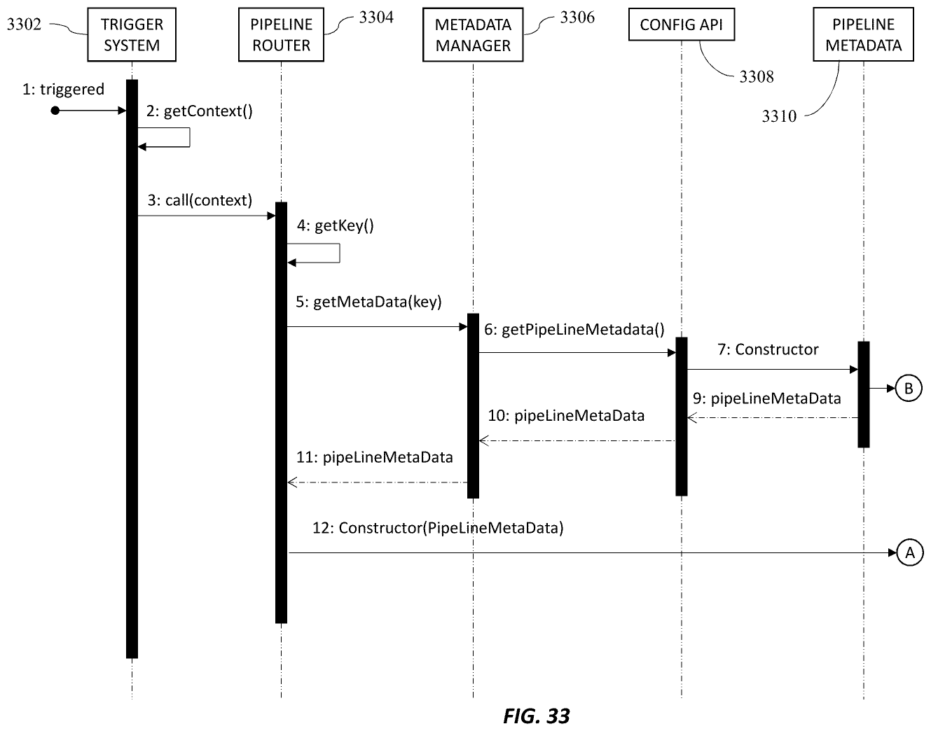

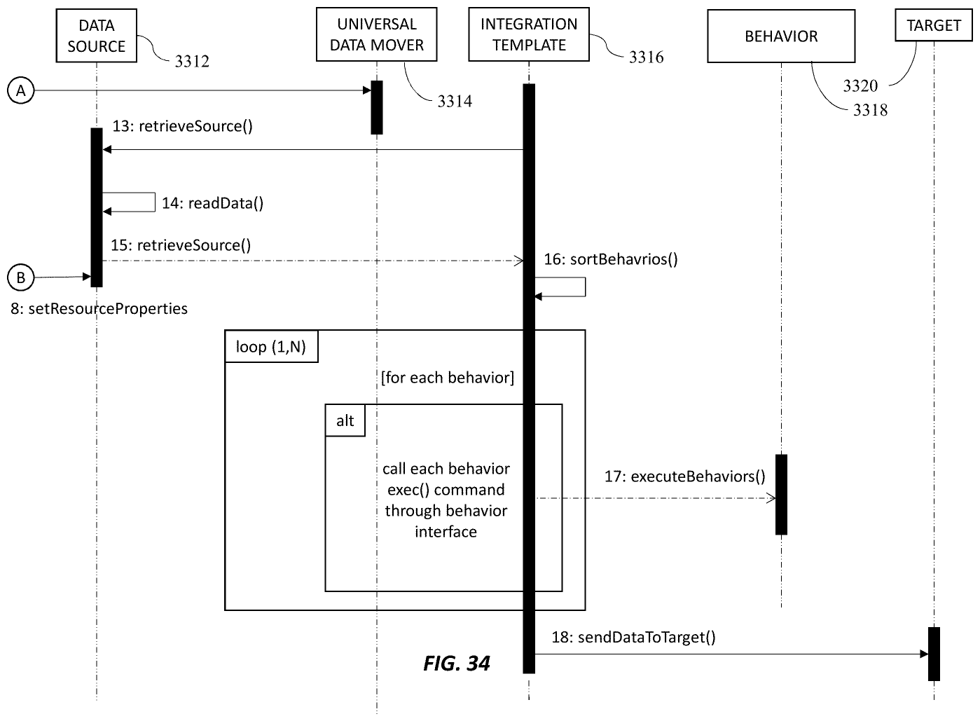

Referencing FIG. 33 and FIG. 34, some embodiments, custom software is configured to handle workflow, behavior execution, and decisions related to non-staged behaviors. Non-staged behaviors can include, for example, logging, instrumentation, micro-batching, and/or retry capability.

In some embodiments, a Trigger System is external to the process; in certain embodiments, a program calls a Universal Data Mover component. Various trigger systems can be used. In one embodiment, a key can be derived from context (such as the file name).

In certain embodiments a Job Scheduling Trigger can be an external job scheduler configured to call the UniversalDataMover. The Job Scheduling Trigger can pass in the key to retrieve the PMD. In one embodiment, a Command Line Trigger (similar to a Job Scheduling Trigger) can be triggered manually by a user and/or another computer program. In one embodiment, a File Watcher Trigger can be a trigger configured to use an existing OS component known as a FileWatcher. When a file is detected by the FileWatcher then a predetermined action is taken; in this case the action is to call the UDM to start the data integration pipeline from Source to Target.

In some embodiments, a Queue/Stream Trigger can be a program that reads from a message queue. This message queue can contain the PMD and then does not need to be retrieved again; then the Metadata Manager, Configuration API, and Pipeline Metadata would already been executed by a program that called the data integration pipeline. Alternatively, the message queue can contain the filename to process or the PMD key; in this case, we would need to go through the Metadata Manager, Configuration API, and Pipeline Metadata.

In one embodiment a Cloud Trigger can be a variation of a Job Scheduling Trigger, a File Watcher Trigger, or a Queue/Stream Trigger, which variation can be provided by an on-cloud platform. In some embodiments, on the arrival of a file or a document in a queue, on-cloud services (for example, a Serverless Function) are executed. In certain embodiments, the UDM can be contained within a cloud's Serverless function feature set. The UDM can be called using triggers available within that cloud platform.

In certain embodiments, a pipeline router component can be used as a trigger. The inventive systems and methods disclosed here can be located and executed (in parts) simultaneously in multiple locations.

In one embodiment, a Pipeline Router component can be configured to determine which data integration environment to execute, and to resolve a trigger signal to a PMD key. A location can be a server or desktop PC within an organization's protected firewall, or it can be a server or Serverless function on the cloud. The Pipeline Router can be configured to reroute traffic to other servers in time of heavy traffic, for example. The Pipeline Router can be configured to reroute some behaviors or data integration pipelines to a predetermine DITTOE execution instance because, for example, that instance is better suited to the data profile, since the data volume is better suited for a distributed platform.

In some embodiments a Metadata Manager can be a component configured call out to the configuration API to get or receive a PMD. In certain embodiments, a Configuration API can be an external interface called to retrieve a PMD. The Configuration API, in some embodiments, can include get and set methods available via web services, and can deliver the PMD in different formats (such as JSON, XML, YAML, and the like).

In one embodiment, a Pipeline Metadata Data Object can contain methods to set and get top level properties of the PMD, and can return a PMD in the format of an object in native construct of a language. The Pipeline Metadata Object is to be distinguished from the textual representation of the PMD that is a runtime object instance.

An integration data pipelines can have a Source and a Target. A Source Resource can be the Source (for example, a File, API, Database, or Stream).

In some embodiments, a Universal Data Mover (UDM) can be a component that is run to execute a data integration pipeline. The UDM can be configured to execute the loop that calls behaviors and moves data to the Target.

In certain embodiments, an Integration Template can be configured to focus on specific Sources, Targets, and behaviors. The UDM can be configured to call a template, which template subsequently calls operations particular to that template. This allows the inventive systems and methods disclosed here to be extensible, and thereby, both data integration pipeline and behavior objects can be customized for a particular use case (of a particular institution's usage pattern, for example).

In some embodiments, a data integration system can be configured with up to eighteen behaviors that can be used with data integration pipelines. In certain embodiments, behaviors can be Staged Behaviors, Non-Staged Behaviors, and External Behaviors. In one embodiments, one or more staged behaviors can be strung together like items in a workflow. Staged Behaviors can have a processing order, with antecedents and next behavior comprising a chain of behaviors. Staged Behaviors can be executed via publish and submission, for example, to a Queue, asynchronously, synchronously, or as part of multiple joined threads. Staged Behaviors can include, for example, compression, masking, transformation, formatting, and/or executing data quality rules. Configuring Staged Behaviors and Non-Staged Behaviors can be advantageous when an integration engine is a custom data integration engine, rather than an external data integration engine. Non-Staged Behaviors can be configured to be separate from a chained workflow, and Non-Staged Behaviors can be ubiquitous throughout the execution code of a data integration pipeline. Examples of Non-Staged Behaviors include instrumentation, logging, lineage tracking, and/or SchemaEvolution. In some embodiments, External Behaviors can be configured to be executed by a workflow or data integration engine that is not a part of a custom data integration project, but rather uses, for example, commercially available data integration tools, ETL, and/or platform. External Behaviors can be used in the PMD definition.

In certain embodiments, trigger system 3302 can receive a trigger signal [1: triggered]. Trigger system 3302 accesses and/or receives context [2: getContextO], and trigger system 3302 makes a call to pipeline router 3304 [3: call(context)]. Pipeline router 3304 gets the key [4: getKey( )] and calls metadata manager 3306 [5: getMetaData(key)]. Metadata manager 3306 executes getPipeLineMetadata( ) [6], which calls Config API 3308. Config API 3308 executes Constructor [7], and communicates with pipeline metadata 3310, which executes setResourceProperties [8]. Pipeline Metadata component 3310 then returns pipeline meta data to config API 3308 [9: PipelineMetaData], which forwards pipe line meta data to metadata manager component 3306 [10: pipelineMetaData]. Metadata manager component 3306 then forwards [11: pipeLineMetaData] pipe line meta data to pipeline router 3304. Pipeline router 3304 then executes Constructor(PipeLineMetaData) [12], which communicates with universal data mover (UDM) component 3314. Integration template 3316 component executes retrieveSource( ) [13]. Data source component 3312 executes readData( ) [14] and retrieveSource( ) [15]. Integration template 3316 executes sortBehaviors [16] and executeBehaviors( ) [17], which communicates with behavior component 3318. Integration template 3316 executes sendDataToTarget( ) [18].

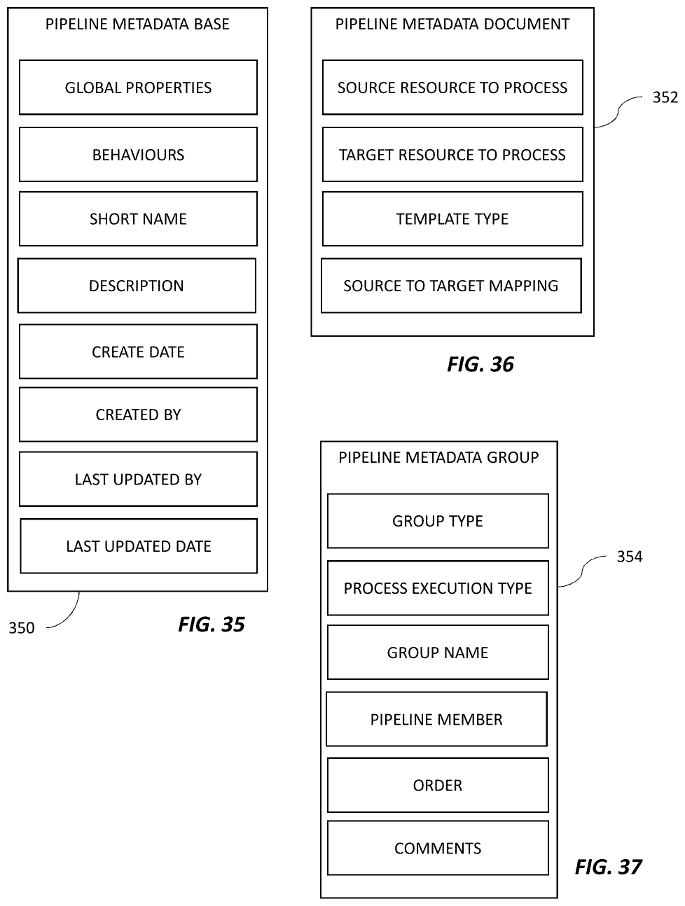

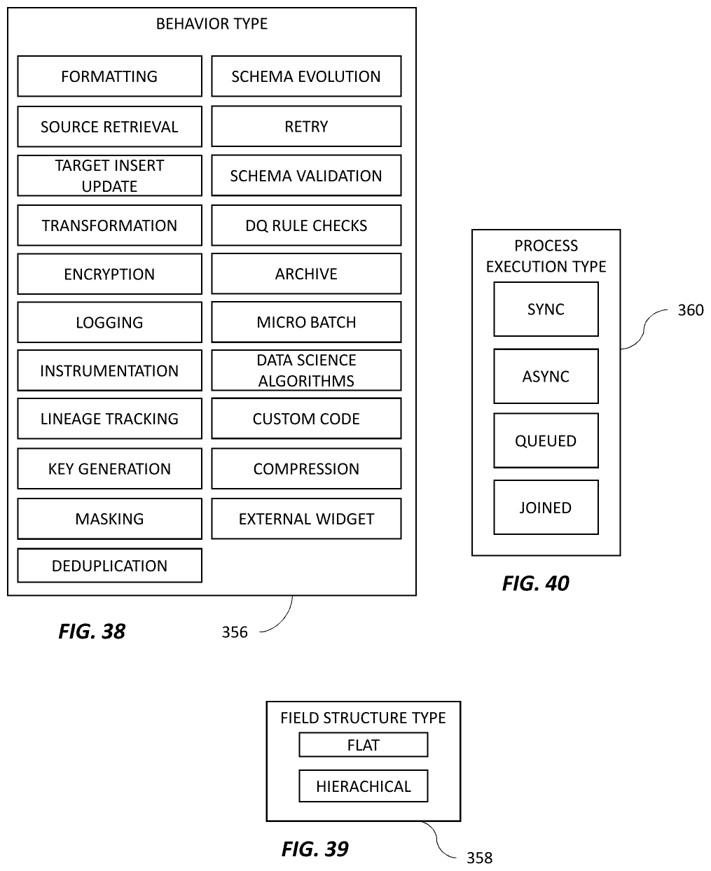

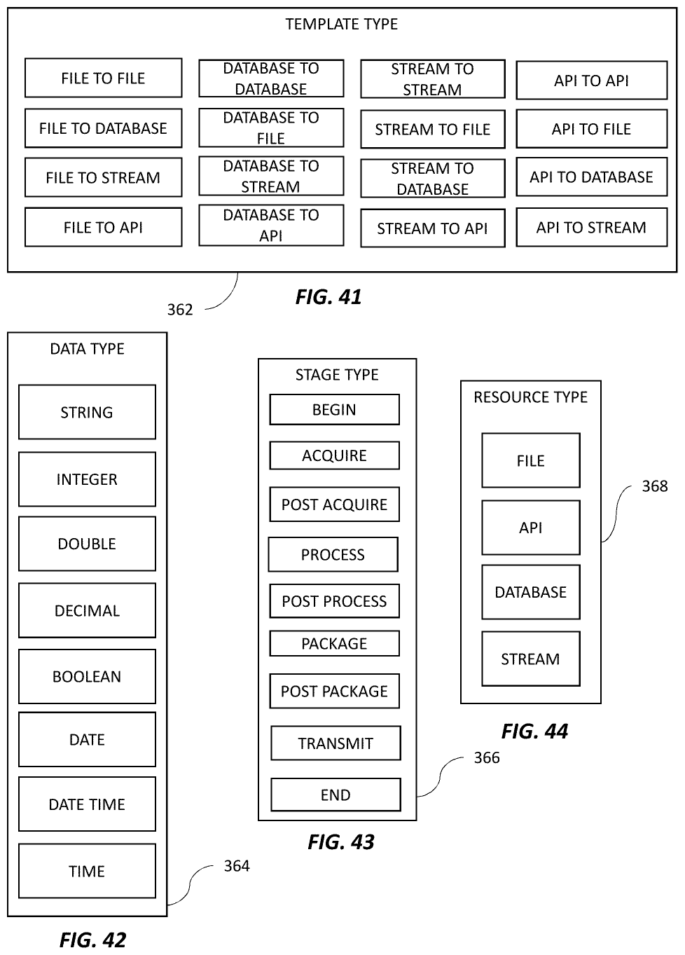

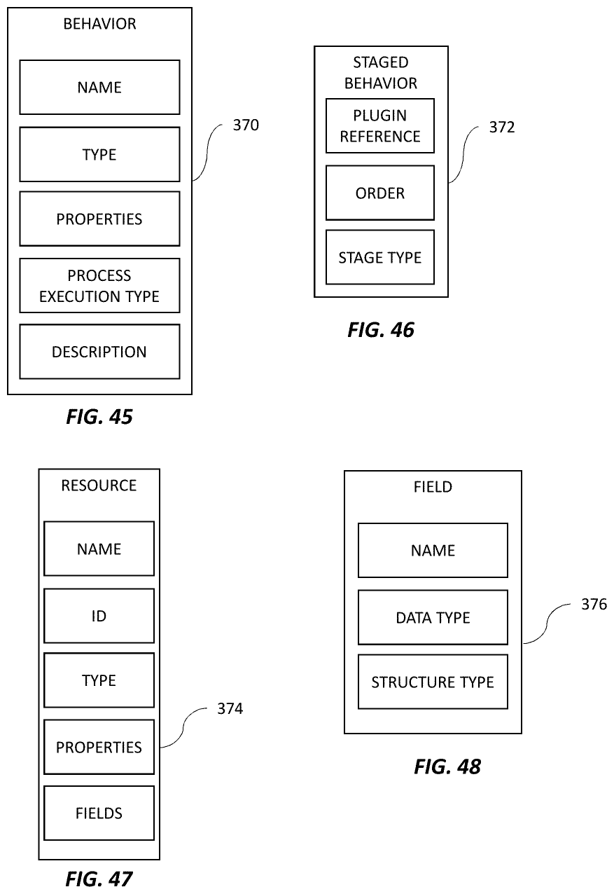

Referencing FIG. 35 to FIG. 48, in some embodiments, a data integration system can include pipeline metadata base component 350, pipeline metadata document 352, pipeline metadata group 354, behavior type structure 356, field structure type structure 358, process execution type structure 360, template type structure 362, data type structure 364, stage type structure 366, resource type structure 368, behavior component 370, staged behavior structure 372, resource components 374 (which can be a Source or a Target), and/or field component 376.

Following are exemplary implementations of certain embodiments of the inventive systems, methods, and components disclosed here.

//this pseudocode represents a custom template of File (JSON) To DB
CALL universalDataMover.run( )

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A method of facilitating data integration, the method comprising:
providing a pipeline metadata document (PMD);
after initiation of execution of a data integration pipeline, retrieving the PMD, wherein the data integration pipeline comprises at least one behavior, the at least one behavior comprising at least one behavior property;
wherein the PMD comprises data associated with the at least one behavior property; and
setting the at least one behavior property with said data associated with the at least one behavior property.

2. The method of claim 1, wherein providing a PMD further comprises providing a document comprising data associated with source information, target information, source-to-target map, and behaviors.

3. The method of claim 1, further comprising providing at least one data integration pipeline template for moving data from a source to a target, wherein each the at least one pipeline template comprises at least one behavior.

4. The method of claim 3, further comprising executing the at least one data integration pipeline template, wherein executing comprises:
acquiring a source data from the source;
applying the at least one behavior to the source data to produce transformed data; and
transferring the transformed data to the target.

5. The method of claim 1, wherein providing a PMD further comprises providing data associated with the execution of least one pipeline template, and wherein said providing data further comprises providing data based on input provided by multiple roles.

6. The method of claim 5, wherein providing data based on input provided by multiple roles comprises providing data provided by a Customer, Solution Architect, Data Architect, Data Analyst, Data Engineer, and Data Quality Specialist.

7. A system for facilitating data integration, the system comprising:
a user interface (UI) for generating at least one pipeline metadata document (PMD);
at least one PMD;
an integration engine configured to retrieve and execute the at least one PMD after initiation of the execution of a data integration pipeline;
wherein the integration engine is further configured to execute at least one behavior, the at least one behavior comprising at least one behavior property; and
wherein the PMD comprises at least one specification associated with the at least one behavior property.

8. The system of claim 7, wherein the UI is configured to communicate with at least one external data source to facilitate generating the PMD.

9. The system of claim 7, further comprising at least one data integration pipeline template.

10. The system of claim 9, wherein the at least one data integration pipeline template comprises the least one behavior.

11. The system of claim 10, further comprising a universal data mover component comprising a set of data integration templates, said set of data integration templates comprising templates for data integration file-to-file, database-to-database, stream-to-stream, api-to-api, file-to-database, database-to-file, stream-to-file, api-to-file, file-to-stream, database-to-stream, stream-to-database, api-to-database, file-to-api, database-to-api, stream-to-api, and api-to-stream.

12. The system of claim 9, wherein the at least one data integration pipeline template comprises at least one stage of execution.

13. The system of claim 10, wherein the at least one stage of execution comprises stages begin, acquire, process, package, transmit, and end.

14. The system of claim 7, further comprising a pipeline router component configured to identify a specific PMD.

15. A pipeline metadata document (PMD) for use in data integration, the PMD comprising:
a first structure configured to store information associated with a data source;
a second structure configured to store information associated with a data target;
a third structure configured to store information associated with a source-to-target mapping; and
a fourth structure configured to store information associated with behaviors of a data integration pipeline.

16. The PMD of claim 15, wherein the first structure comprises data associated with source properties and source fields.

17. The PMD of claim 15, wherein the second structure comprises data associated with target properties and target fields.

18. The PMD of claim 15, wherein the third structure comprises data associated with a source field, a source target, and a transformation rule.

19. The PMD of claim 15, wherein the fourth structure comprises data associated with behavior properties and behavior type.

20. The PMD of claim 15, wherein the PMD is configured to be stored in, and retrieved from, a repository configured to store a plurality of PMDs.
